(19) United States
(12) Patent Application Publication
(10) Pub. No.: US 2005/0203789 A1
(43) Pub. Date: Sep. 15, 2005

(54) Activity management system and method of using

(75) Inventors: Eric Kauffman, Austin, TX (US); Paul Brown, Austin, TX (US)

Correspondence Address: OBLON, SPIVAK, MCCLELLAND, MAIER & NEUSTADT, P.C., 1940 DUKE STREET, ALEXANDRIA, VA, 22314, US

(73) Assignee: TOKYO ELECTRON LIMITED, Tokyo (JP)

(21) Appl. No.: 10/799,892

(22) Filed: Mar. 15, 2004

(51) Int. Cl. G06F 17/60

(52) U.S. Cl. 705/8

(57) ABSTRACT

An activity management system, and a method of using thereof, is described for a service process in semiconductor manufacturing. The activity management system includes a data collection system configured to receive service activity data associated with at least one service component and a service operator, and relate the service activity data with at least one service account. Additionally, the activity management system includes a data storage system coupled to the data collection system and configured to store the service activity data. Furthermore, the activity management system includes a service action system coupled to the data collection system and the data storage system, and configured to perform at least one service function including service component repair, service component start-up, service component preventive maintenance, service component cleaning, service component revision (e.g., a field change notice), a service component enhancement (e.g., a continuous improvement notice), service component de-installation, a customer action plan, a project action plan, and service education.

### BACKGROUND OF THE INVENTION

1. Field of the Invention

The present invention relates to an activity management system and method of using, and, more particularly, to an activity management system configured to manage service activities relating to semiconductor manufacturing systems.

2. Description of Related Art

Maintaining a semiconductor manufacturing facility is a time-consuming and expensive procedure that involves collaboration between equipment manufacturers and the manufacturing facility. The inefficient interaction between a semiconductor equipment manufacturer and a semiconductor manufacturing facility can result in facility downtimes that add to the overall operational cost, as well as excessive consumption of engineering time and hardware replacements.

In the electronics industry, equipment manufacturers utilize a number of separate, independent service models configured to address activities ranging from manufacturing system maintenance, to manufacturing system trouble-shooting, to hardware replacement and approval, to part replacement and approval, etc. More generally, service models relating to services such as repair and replacement of specific components are not integrated with service models relating to general management tasks such as scheduling and evaluation. As a result, these service models exhibit a lack of communication of data between one another, significant overlap leading to redundancies, as well as establishing virtual boundaries within the structure designed to facilitate equipment service. The present inventors have recognized that this use of independent service models leads to increased service costs and reduced operating efficiency.

### SUMMARY OF THE INVENTION

Accordingly, one aspect of the invention is to reduce or eliminate any or all of the above-described problems.

Another object of the present invention is to reduce service costs and maximize operating efficiency in the maintenance of a semiconductor manufacturing facility.

Yet another object of the present invention is to provide a system for integrating management activities of semiconductor manufacturing facility.

These and or other objects of the present invention are provided by an activity management system for managing services relating to semiconductor manufacturing. The system includes a data collection system configured to receive service activity data relating to at least one of a service component a service operator, and a service account. A data storage system is coupled to the data collection system and configured to store the service activity data, and a service action system is coupled to the data collection system and the data storage system. The service action system is configured to provide service action data using the service activity data in order to perform at least two of a plurality of service functions including providing service component repair, providing service component start-up, providing service component preventative maintenance, providing service component cleaning, providing service component revisions, providing service component enhancements, providing service component de-installation, providing service education, and providing service collaboration.

According to another aspect of the invention, a method of using an activity management system to assist in performing a service action relating to semiconductor manufacturing. The method includes providing a data collection system configured to interact with a service operator and collect service activity data from the service operator, wherein the service activity data is associated with at least one of a service component, a service operator and a service account. A data storage system is provided coupled to the data collection system, and configured to store the service activity data; providing a data action system coupled to the data collection system and the data storage system, and configured to interact with the service operator and provide service action data to the service operator using the service activity data stored in the data storage system. The service action data is utilized to perform a service function including at least one of service component repair, providing service component start-up, providing service component preventative maintenance, providing service component cleaning, providing service component revisions, providing service component enhancements, providing service component de-installation, providing service education, and providing service collaboration.

Still another aspect of the invention is an activity management system for managing service activities relating to semiconductor manufacturing. The system includes a data collection system configured to collect service activity data relating to semiconductor manufacturing services, a data storage system coupled to the data collection system and configured to store the service activity data, and a service action system coupled to the data collection system and data storage system. The service action system is configured to perform a service component service function and a non-service component service function in order to assist a service operator in performing a service action.

Yet another aspect of the invention is a method of using a computer system to manage service activities relating to semiconductor manufacturing. The method includes using the computer system to collect service activity data relating to semiconductor manufacturing services, using the computer system to store the service activity data, and using the computer system to perform a service component service function and a non-service component service function. A service action is performed based on results of the service component or non-service component service function.

In another aspect of the invention, a computer readable medium containing program instructions for execution on a processor, which when executed by the processor, cause a computer system to perform the steps in the method of the invention.

Still another aspect of the invention includes an activity management system for managing service activities relating to semiconductor manufacturing. The system includes means for collecting service activity data relating to semiconductor manufacturing services, means for storing the service activity data coupled to the means for collecting, and means, coupled to the means for collecting and the means for storing, for performing a service component service function and a non-service component service function in order to assist a service operator in performing a service action.

### BRIEF DESCRIPTION OF THE DRAWINGS

In the accompanying drawings:

FIG. 1 presents a schematic diagram of an activity management system according to an embodiment of the invention;

FIG. 2A illustrates a first exemplary operator interface for a service operator to gain access to the activity management system of FIG. 1;

FIG. 2B illustrates a second exemplary operator interface for a service operator to gain access to the activity management system of FIG. 1;

FIG. 2C illustrates an exemplary schematic illustration of an operator interface for access to the activity management system of FIG. 1;

FIG. 3A illustrates an exemplary operator interface for accessing a service function;

FIG. 3B illustrates another exemplary operator interface for performing the service function depicted in FIG. 3A;

FIG. 3C illustrates another exemplary operator interface for performing the service function depicted in FIG. 3A;

FIG. 3D illustrates another exemplary operator interface for performing the service function depicted in FIG. 3A;

FIG. 3E illustrates another exemplary operator interface for performing the service function depicted in FIG. 3A;

FIG. 3F illustrates another exemplary operator interface for performing the service function depicted in FIG. 3A;

FIG. 3G illustrates another exemplary operator interface for performing the service function depicted in FIG. 3A;

FIG. 3H illustrates another exemplary operator interface for performing the service function depicted in FIG. 3A;

FIG. 3I illustrates another exemplary operator interface for performing the service function depicted in FIG. 3A;

FIG. 3J illustrates another exemplary operator interface for performing the service function depicted in FIG. 3A;

FIG. 3K illustrates another exemplary operator interface for performing the service function depicted in FIG. 3A;

FIG. 4A illustrates another exemplary operator interface for accessing another service function;

FIG. 4B illustrates another exemplary operator interface for performing the service function depicted in FIG. 4A;

FIG. 4C illustrates another exemplary operator interface for performing the service function depicted in FIG. 4A;

FIG. 5A illustrates another exemplary operator interface for accessing another service function;

FIG. 5B illustrates another exemplary operator interface for performing the service function depicted in FIG. 5A;

FIG. 5C illustrates another exemplary operator interface for performing the service function depicted in FIG. 5A;

FIG. 6 illustrates another exemplary operator interface for accessing another service function;

FIG. 7A illustrates another exemplary operator interface for accessing another service function;

FIG. 7B illustrates another exemplary operator interface for performing the service function depicted in FIG. 7A;

FIG. 8A illustrates another exemplary operator interface for accessing another service function;

FIG. 8B illustrates another exemplary operator interface for performing the service function depicted in FIG. 8A;

FIG. 8C illustrates another exemplary operator interface for performing the service function depicted in FIG. 8A;

FIG. 8D illustrates another exemplary operator interface for accessing another service function;

FIG. 8E illustrates another exemplary operator interface for accessing another service function;

FIG. 8F illustrates another exemplary operator interface for performing the service function depicted in FIG. 8E;

FIG. 9 illustrates another exemplary operator interface for accessing another service function;

FIG. 10A illustrates another exemplary operator interface for accessing another service function;

FIG. 10B illustrates another exemplary operator interface for performing the service function depicted in FIG. 10A;

FIG. 10C illustrates another exemplary operator interface for performing the service function depicted in FIG. 10A;

FIG. 11A illustrates another exemplary operator interface for accessing another service function;

FIG. 11B illustrates another exemplary operator interface for performing the service function depicted in FIG. 11A;

FIG. 12A illustrates another exemplary operator interface for accessing another service function;

FIG. 12B illustrates another exemplary operator interface for performing the service function depicted in FIG. 12A;

FIG. 13A illustrates another exemplary operator interface for accessing another service function;

FIG. 13B illustrates another exemplary operator interface for performing the service function depicted in FIG. 13A;

FIG. 14A illustrates another exemplary operator interface for accessing another service function;

FIG. 14B illustrates another exemplary operator interface for performing the service function depicted in FIG. 14A;

FIG. 15A illustrates another exemplary operator interface for accessing another service function;

FIG. 15B illustrates another exemplary operator interface for performing the service function depicted in FIG. 15A;

FIG. 15C illustrates another exemplary operator interface for performing the service function depicted in FIG. 15A;

FIG. 15D illustrates another exemplary operator interface for performing the service function depicted in FIG. 15A;

FIG. 16A illustrates another exemplary operator interface for accessing another service function;

FIG. 16B illustrates another exemplary operator interface for performing the service function depicted in FIG. 16A;

FIG. 17A illustrates another exemplary operator interface for accessing another service function;

FIG. 17B illustrates another exemplary operator interface for performing the service function depicted in FIG. 17A;

FIG. 18A illustrates another exemplary operator interface for accessing another service function;

FIG. 18B illustrates another exemplary operator interface for performing the service function depicted in FIG. 18A;

FIG. 18C illustrates another exemplary operator interface for performing the service function depicted in FIG. 18A;

FIG. 18D illustrates another exemplary operator interface for performing the service function depicted in FIG. 18A;

FIG. 18E illustrates another exemplary operator interface for performing the service function depicted in FIG. 18A;

FIG. 18F illustrates another exemplary operator interface for performing the service function depicted in FIG. 18A; and

FIG. 19 illustrates a computer system upon which an embodiment of the present invention may be implemented.

### DETAILED DESCRIPTION OF EXEMPLARY EMBODIMENTS

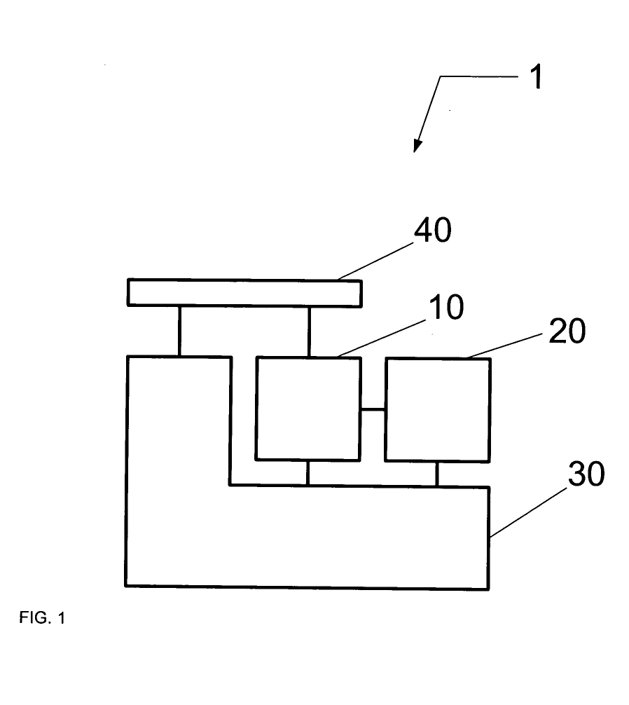

Referring now to the drawings wherein like reference numerals designate identical or corresponding parts throughout the several views, FIG. 1 presents an activity management system 1 for managing service activities relating to semiconductor manufacturing. The activity management system 1 includes a data collection system 10, a data storage system 20, a service action system 30 and an operator interface 40. The data collection system 10 is configured to receive service activity data relating to the management and performance of services, and the service activity data is stored in the data storage system 20. The service action system 30 uses the service activity data to perform service functions. A service function is a software function performed by the activity management system 1 to assist a service operator in performing service actions. A service action may be an equipment repair, a decision relating to the scheduling of maintenance, an evaluation of a service operator or any other action relating to services in semiconductor manufacturing. In one embodiment, the service action system 30 performs service functions to provide service action data used in performing a specific service action. For example, the service action system 30 may parse the service activity data in the data storage system 20 to provide service action data in the form of step-by-step instructions for performing a maintenance procedure on semiconductor processing equipment. Specific service functions performed by the activity management system 1 are described in detail below.

The service activity data collected by the data collection system 10 may be collected by manual input from a service operator, or automatic input such as from manufacturing equipment sensors. The service activity data is preferably stored in the data storage system 20 in association with at least one of a service operator, a service account and a service component. A service operator can, for example, include a service supervisor (or manager), service designer, service analyst, a service engineer (such as a field engineer) or any other person involved in service activities relating to semiconductor manufacturing. Service activity data corresponding to a service operator can, for example, include the name of the service operator, the title of the service operator, the site where the service operator performs his or her primary duties (e.g., a manufacturing facility, customer site, etc.), the name of the supervisor, phone number, address, electronic mail address, reference files, photo files, etc.

A service account can, for example, include at least one of a service contract, a service warranty, and a manufacturing system (MS) department. A service account may be any obligation to perform services such as a warranty negotiated between a semiconductor manufacturing facility and the equipment manufacturer. Service activity data corresponding to a service account can, for example, include the agreement number, the title of the service agreement (e.g., one year 24×7 Parts & Labor Warranty), the coverage hours (24×7), an identification of the items coverage (e.g., non-consumables, repair labor, start up labor), an identification of the non-coverage items (e.g., consumables, customer damage), list price (e.g., the list price can be based upon existing service activity data in the activity management system), penalties (e.g., one month added for month below 93% availability), dedication of service operator to manufacturing facility, warranty or contract starting date, warranty or contract ending date, warranty or contract invoice date, warranty or contract payment date, etc. Service agreements can be assigned to service components, as well as to manufacturing facilities (i.e., customers).

A service component can, for example, include a manufacturing system (MS) platform, a manufacturing system (MS) tool, or a manufacturing system (MS) part. For example, the MS platform can include a cluster-tool arrangement, such as a Unity II, a Unity IIe, a Unity M, or a Unity ME, or a serial tool arrangement, such as a Telius platform, for performing semiconductor manufacturing processes, which are commercially available from Tokyo Electron Limited (TBS Broadcast Center, 3-6 Akasaka 5-chome, Minato-ku, Tokyo 107-8481). Additionally, for example, the MS platform can include an ACT 8, ACT 12, or Lithius Track System commercially available from Tokyo Electron Limited. Additionally, for example, the MS platform can include an Alpha Series, or TELFormula batch processing Thermal Processing System commercially available from Tokyo Electron Limited. Additionally, for example, the MS platform can include a Trias Deposition System commercially available from Tokyo Electron Limited. The MS tool can, for example, include a DRM, A-DRM, DRM II, SCCM-DT, SCCM-Ox, or SCCM-Poly Etch System, or a SPA Deposition System. More generally, the MS tool can, for example, include an etch system; a deposition system such as a thermal deposition system, a chemical vapor deposition (CVD) system, an atomic layer deposition (ALD) system, a physical vapor deposition (PVD) system, or an ionized PVD (I-PVD) system; a photoresist spin coating system; a spin-on dielectric system; a cleaning system such as a liquid immersion system or a supercritical fluid cleaning system; a thermal processing system such as a batch processing oxidation, diffusion, low pressure CVD furnace, or a thermal curing system; a rapid thermal processing (RTP) system, a lithography system; an ion implant system; a planarization system; an electro-plating system; a device probing system; a metrology system, etc. The MS part can, for example, include a non-consumable, or consumable part in the MS tool.

Service activity data corresponding to a service component can, for example, include the type of MS platform, the model number for the MS platform, the serial number for the MS platform, the type of MS tool, the process associated with the specific MS tool, the model number for the MS tool, the serial number for the MS tool, the MS parts associated with the specific MS tool, the type of MS part, the model number for the MS part, the serial number for the MS part, the identification of the existence of spare parts, the identification of consumable parts, and MS part cost(s).

Service activity data may also include more general information such as service date, service time, service type, service description, service location, and service reason. Moreover, for example, service activity data can include approval status data, rejection status data, shipping status data, receiving status data, request status data, etc.

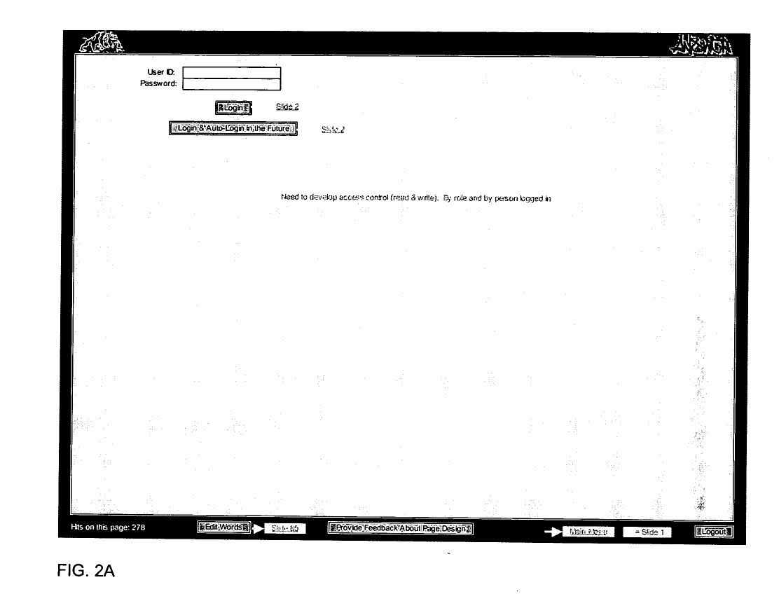

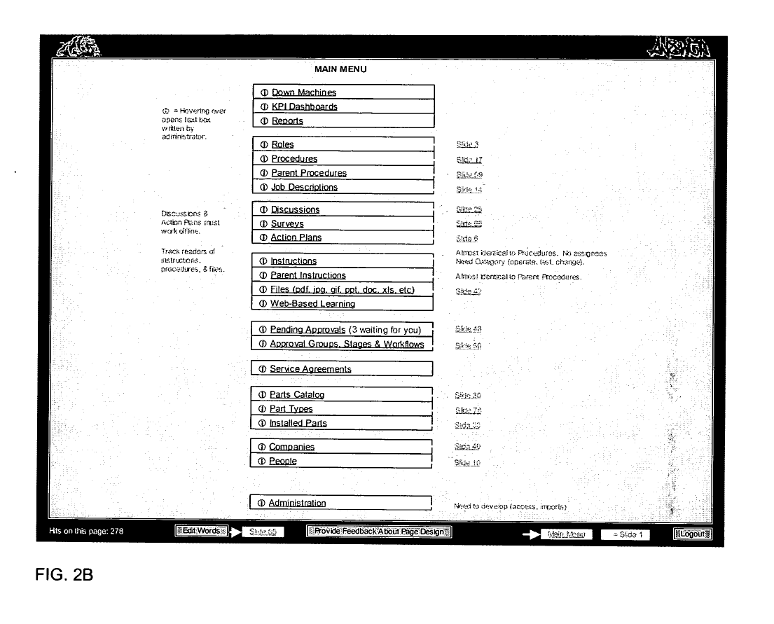

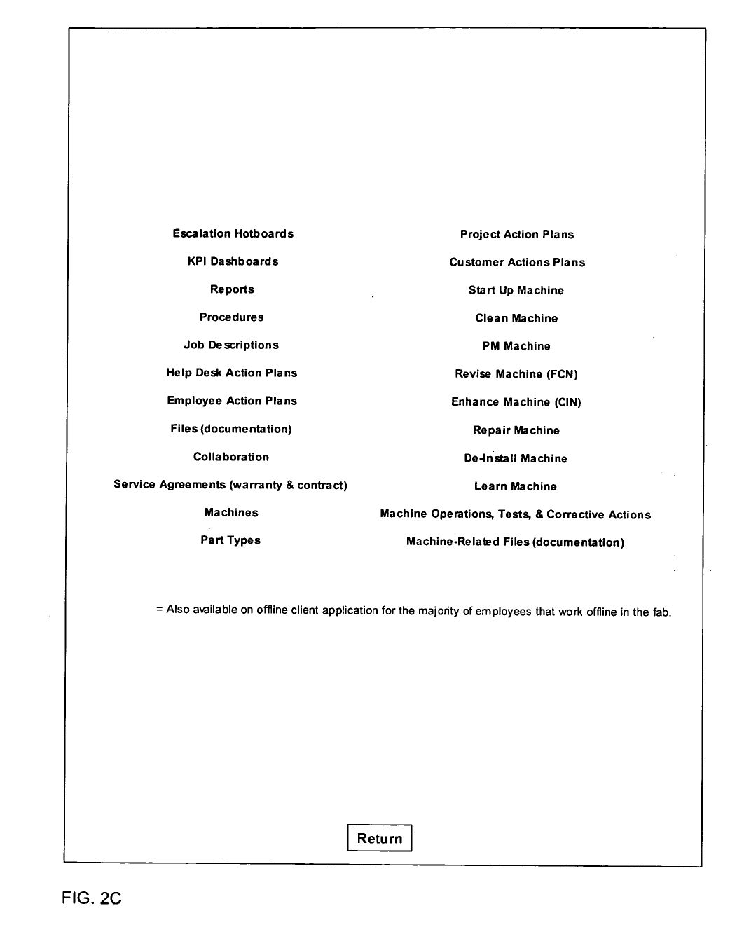

As noted above, in FIG. 1, the activity management system 1 can further include an operator interface 40 coupled to the data collection system 10 and the data action system 30. Service activity data can be tracked and stored in the data storage system 20 through the data collection system 10 using the operator interface 40. Additionally, service action data can be provided to the service operator through the operator interface 40. The interface may be textual or graphical and may be multi-lingual. For example, the operator interface can include a graphical user interface (GUI). A GUI enables the activity management system 1 to perform the desired service activity data acquisition, monitoring, modeling, and service function actions. FIG. 2A illustrates an exemplary GUI having a logon screen with user identification and password fields. Once a service operator enters the activity management system 1, they can be presented with another GUI screen presenting one or more options for performing service functions, as illustrated in FIG. 2B. Those skilled in the art will recognize that GUI screens can comprise a left-to-right selection tab structure and/or a right-to-left structure, a bottom-to-top structure, a top-to-bottom structure, or a combination structure. Those skilled in the art will recognize that GUI screens can comprise a selection tabs structure and/or a navigation tree structure. Additionally, as part of the interface, a keyboard, a mouse, a touch-screen, or any combination thereof can be provided.

The activity management system 1 can include a web-based software application for use where internet access is available, or it may include a downloadable client software application for use where internet access is not available. For example, the latter case can be applicable to use in a semiconductor manufacturing facility.

The activity management system 1 can provide access control. For example, the activity management system 1 is only accessible to the service provider. Additionally, for example, read and write access rules can be configured per user and the role of the user. Additionally, for example, the activity management system can utilize data encryption. Additionally, the activity management system can limit the disclosure of certain documents to only those approved. Additionally, the activity management system 1 can track the users accessing various documents. The activity management system 1 can provide revision control by, for instance, tracking revisions to instructions, documents, procedures, tests, key point indicators (KPIs), etc.

As illustrated in FIG. 2C, an exemplary graphical user interface (GUI) is provided in order to highlight one or more service functions provided by the activity management system. The GUI provides several options for performing a service function. For example, several service functions are specifically related to service components or machines; such service component service functions include performing service component start-up, i.e., “Start Up Machine” key; performing service component cleaning, i.e., “Clean Machine” key; performing service component preventative maintenance, i.e., “PM Machine” key; performing service component revisions, i.e., “Revise Machine (FCN)” key; performing service component enhancements, i.e., “Enhance Machine” key; performing service component repairs, i.e., “Repair Machine” key; performing service component de-installation, i.e., “De-install Machine” key; and performing service component education, i.e., “Learn Machine” key.

As seen in FIG. 2C, service function may not be specifically related to service components; such non-service component service functions include performing project action plans, i.e., “Project Action Plans” key; and performing customer action plans, i.e., “Customer Action Plans” key. Additionally, as illustrated in FIG. 2C, the GUI provides non-service component service functions that allow access to a service operator for integrating a new test or corrective action, and amending a current test or corrective action, using the “Machine Operations, Tests, & Corrective Actions” key. Additionally, as illustrated in FIG. 2C, the GUI provides access to the service operator for entering new documentation pertaining to a MS platform, a MS tool, a MS part, or a MS service agreement, using the “Machine-Related Files (documentation)” key.

Additionally, as illustrated in FIG. 2C, GUI provides non-service component service functions that allow access to a service operator for reviewing, entering, or amending escalation hot-boards, e.g., using the “Escalation Hotboards” key; key performance indicator (KPI) dashboards, e.g., using the “KPI Dashboard” key; reports, e.g., using the “Reports” key; procedures, e.g., using the “Procedures” key; job descriptions, e.g., using the “Job Descriptions” key; help desk action plans, e.g., using the “Help Desk Action Plans” key; employee action plans, e.g., using the “Employee Action Plans” key; files (documentation), e.g., using the “Files (documentation)” key; collaboration, e.g., using the “Collaboration” key; MS service agreements, e.g., using the “Service Agreements (warranty & contract)” key; MS platforms and MS tools, e.g., using the “Machines” key; and MS parts, e.g., using the “Part types” key.

According to one embodiment, the activity management system 1 performs the service functions noted above to provide service action data that assists service personnel in performing service actions. For example, the service action data can include an interactive case study for service component repair. The service action system 30 can identify one or more cases where the current service activity data substantially matches past service activity data, and utilize this correlation to assist the service operator in conducting the service component repair. If necessary, the service action system 30 can identify one or more tests to perform in order to narrow down the number of matching cases. Additionally, the test procedures, specific to a MS platform and a MS tool, can be made accessible to the service operator. The test procedures can be stored in the data storage system 20. As tests are performed and results are retrieved by the data collection system 10, the number of matching cases is reduced. For instance, the activity management system 1 can assist in identifying the MS part to replace in the MS tool in order to correct the problem. Once the MS part is identified, a procedure, specific to a MS platform and a MS tool, can be made accessible to the service operator. The replacement procedures can be stored in the data storage system 20.

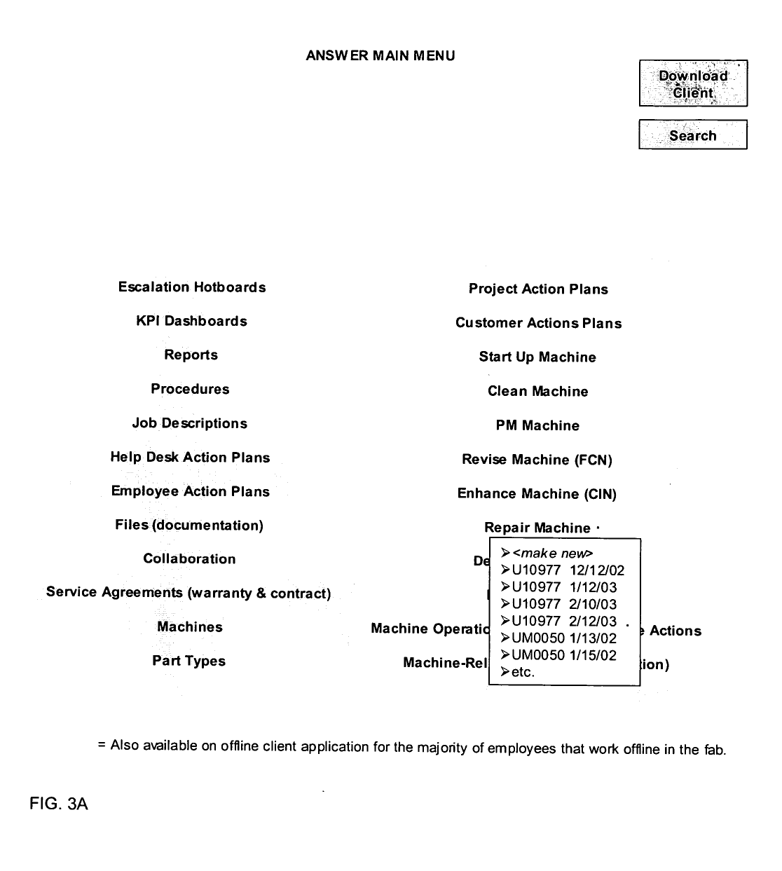

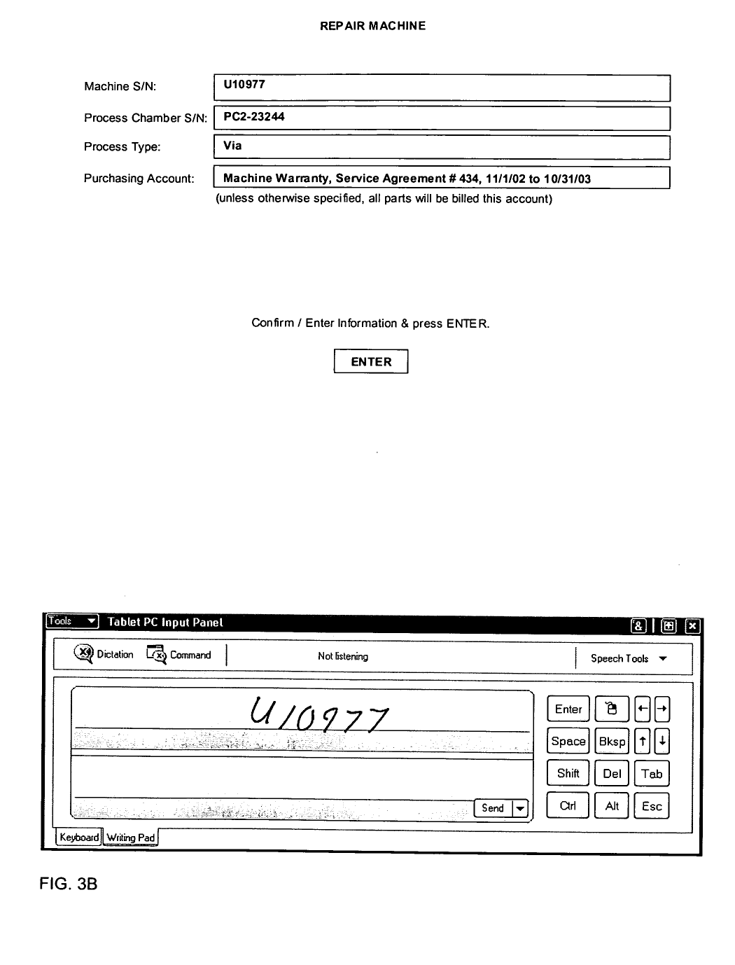

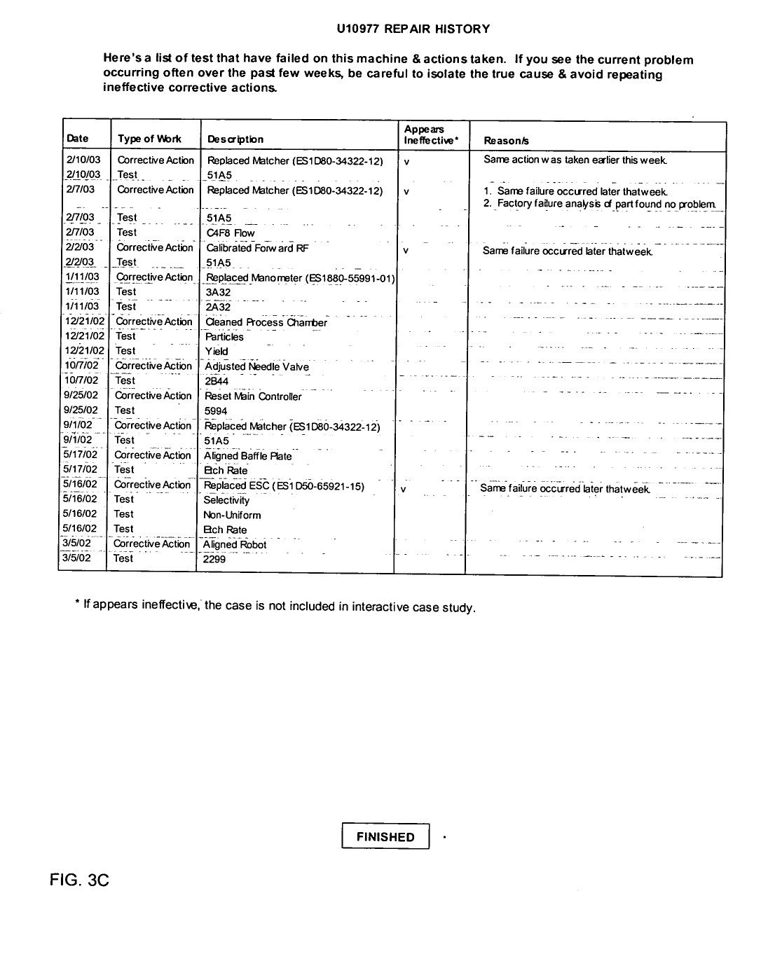

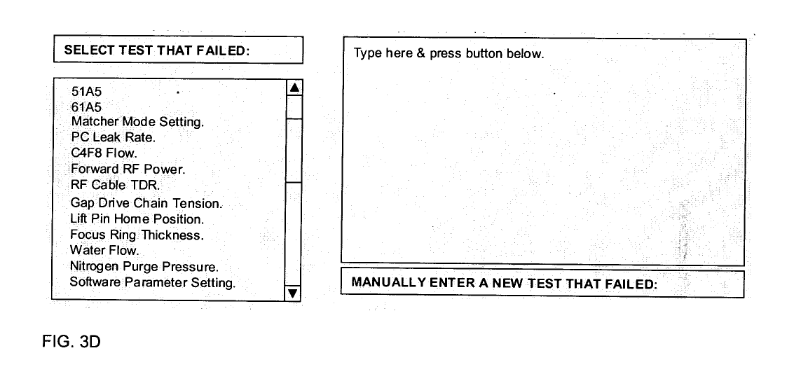

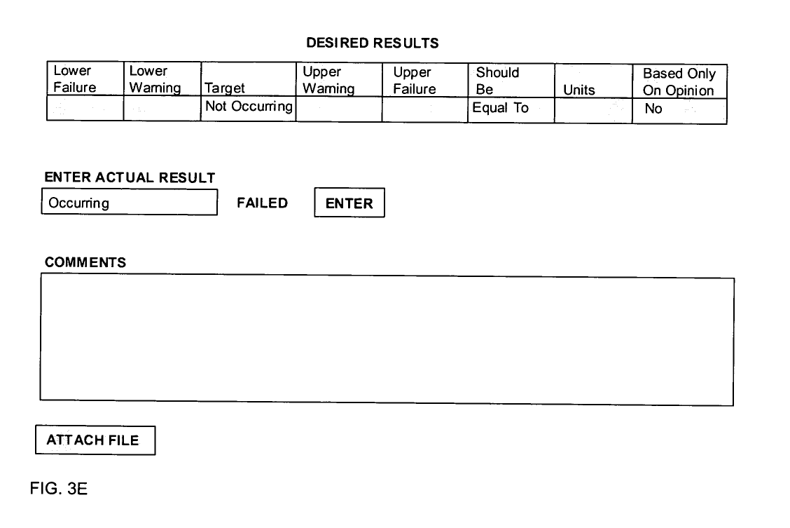

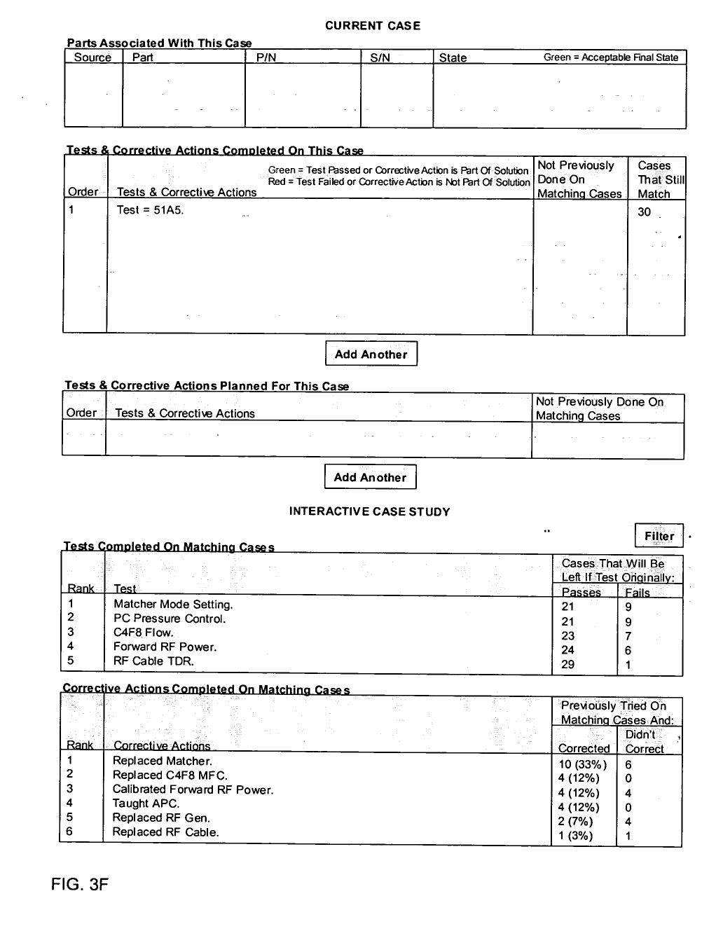

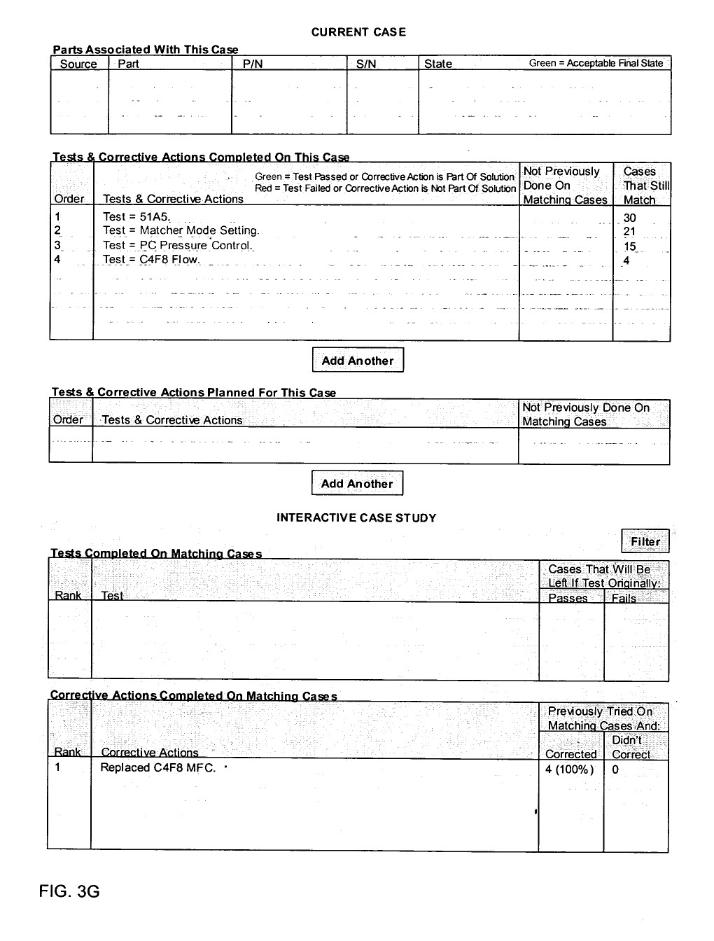

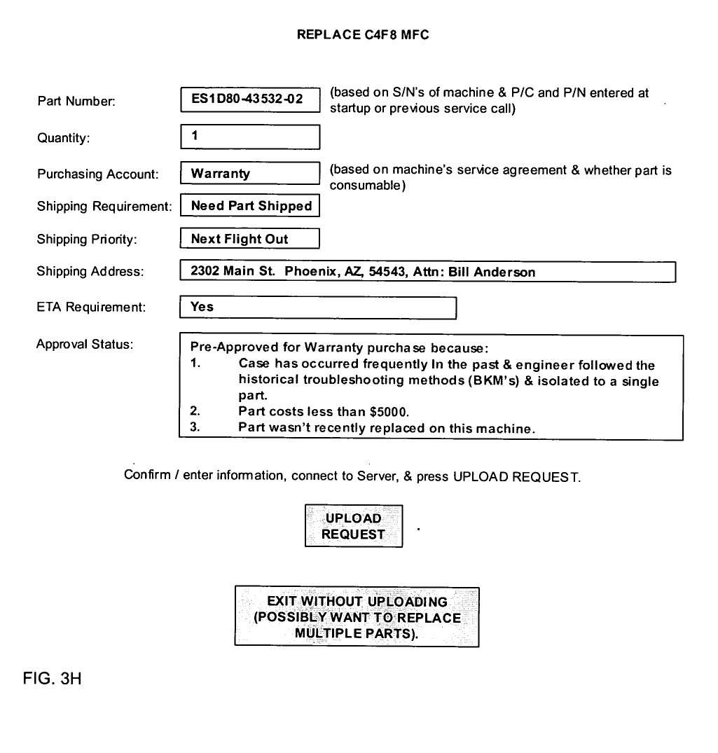

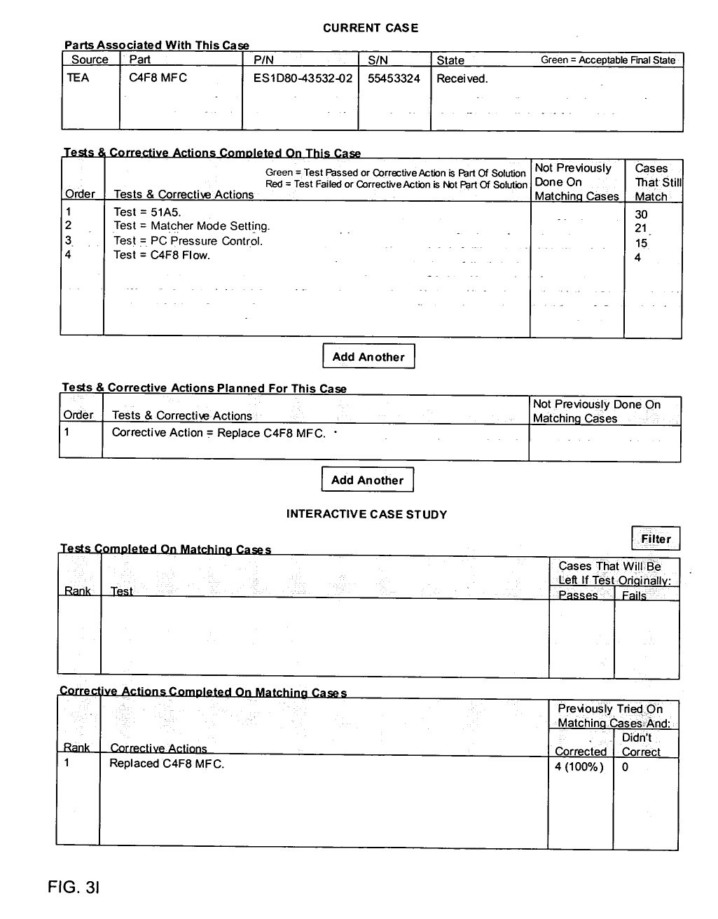

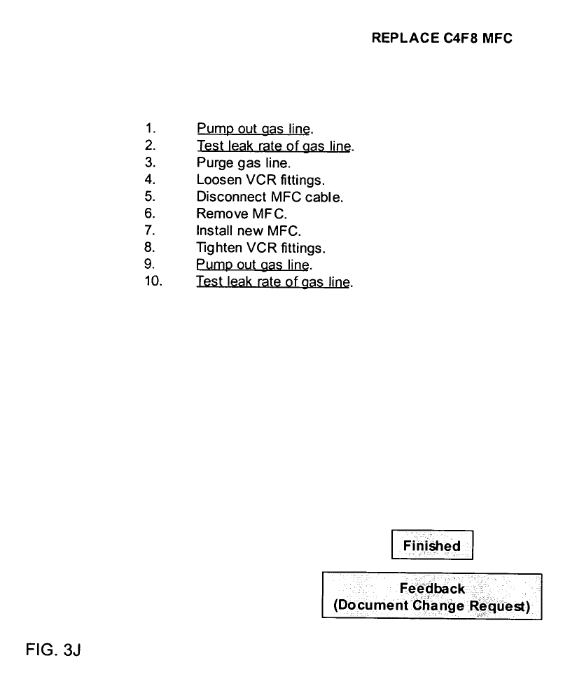

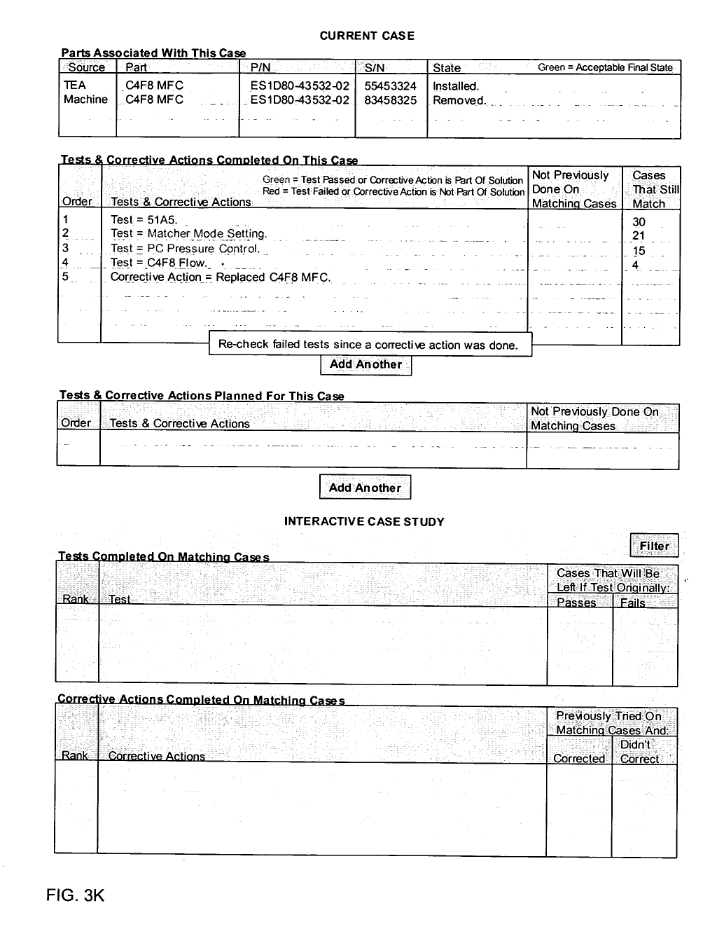

FIGS. 3-18 show examples of graphical user interface screens provided by the activity management system to interface with the system user in performing various service functions.

FIG. 3A illustrates an exemplary operator interface for performing a service component repair using the activity management system in accordance with one embodiment of the invention. In this example, the service operator has received a fault from a MS tool in a MS platform, and has elected to utilize the activity management system to determine a corrective action for the fault. The fault can, for example, include a high reflected power on an impedance match network used for matching the output electrical impedance of a radio frequency (RF) generator with the input electrical impedance of a plasma processing system, such as an etch system. As seen in FIG. 3A, the service operator executes the activity management system, and activates the service component repair function by selecting the “Repair Machine” key.

Once activated, the operator interface 40 of activity management system 1 enables the service operator to identify service activity data including the MS platform (by, for example, machine serial number), the MS tool (by, for example, process chamber serial number), and the process type in connection with the service account (or purchase account); see FIG. 3B. Thereafter, service action system 30 can provide a list of the repair history for the identified MS platform and MS tool; see FIG. 3C. For example, as shown in FIG. 3C, the service action system 30 acquires service activity data from the data storage system 20, and presents this historical data to the service operator. The service activity data can include the service date, service type, service description, and service reason. For instance, the service type indicates whether the service included a test, or included corrective action.

Furthermore, the data collection system 10 enables the service operator to identify the fault, or the test that failed; see FIG. 3D. If the test failure (or fault) is a known fault, then it can be displayed on the left-hand side of the operator interface. If the test failure is not a known fault, the interface enables the service operator to enter the test failure.

Referring now to FIG. 3E, the service operator enters the results of the test failure reported from the MS platform and MS tool. This service activity data is stored in the data storage system 20. Also shown in FIG. 3E, the data action system 30 provides some of the test plan data including, for example, the lower failure limit, the lower warning limit, the target result, the upper warning limit, the upper failure limit, the mathematical operator for comparing the target and actual results, the units of measurement, and whether the results are based upon opinion or not.

Referring now to FIG. 3F, the data action system 30 searches the data storage system 20 for other service activities (or cases) matching the current test failure, or fault. For example, the data action system 30 can present the tests and corrective actions performed for the current service activity (or case). Additionally, for example, the data action system 30 can present the tests, and corrective actions planned for the current service activity (or case). Additionally, for example, the data action system 30 can present the MS parts associated with the current service activity (or case). Additionally, the data action system 30 can present the tests completed on matching cases, as well as the corrective actions completed on matching cases. As illustrated in FIG. 3F, thirty (30) past cases match the current case. In the completed tests and corrective action list, the service operator can edit the results, add another completed test or corrective action to the end of the list, add another test or corrective action to the list of planned tests or corrective actions, review the test procedures for a specific MS platform, MS tool, MS part, or MS service agreement, review the test specifications for a specific test, or review the procedures for a specific corrective action. In the planned tests and corrective action list, the service operator can add the test or corrective action to the completed list, delete the test or corrective action, move the test or corrective action up or down in the list, review the test procedures for a specific MS platform, MS tool, MS part, or MS service agreement, review the test specifications for a specific test, or review the procedures for a specific corrective action.

For instance, the data action system 30 can provide an interactive case study as described above, wherein the tests completed on the matching cases, and the corrective actions completed on the matching cases are itemized. For those tests completed on the matching cases, the data action system 30 can rank (or prioritize) the tests by indicating the number of cases that will be left if the test is performed and passes, as well as the number of cases that will be left if the test is performed and fails. For instance, when the mass flow controller for C₄F₈ process gas is tested, the number of cases remaining if the test passes is twenty-one (21), and the number of cases remaining if the test fails is seven (7). Furthermore, for those corrective actions completed on the matching cases, the data action system 30 can rank (or prioritize) the corrective actions by indicating the number of cases (or percentage (%) of cases) that will be corrected when the corrective action is performed, and the number of cases that will not be corrected when the corrective action when the corrective action is performed. For instance, when the mass flow controller for C₄F₈ process gas is replaced, the number of cases corrected were four (4), and the number of cases not corrected were zero (0).

Using the action data presented by the data action system 30 (see FIG. 3F), the service operator can, for example, elect to perform a test. For instance, the service operator may perform one or more tests, and check the “Matcher Mode Setting”, the “PC Pressure Control”, and the “C4F8 Flow”. When the service operator has elected to perform one or more tests, and proceeds to perform these tests, the service operator can obtain test procedures for performing the test that is specific to the MS part, specific to the MS tool, and specific to the MS platform. In this example, this test results include a pass, pass, and fail, respectively, as shown in FIG. 3G. While performing these tests, the number of matching cases is reduced from thirty (30), to twenty one (21), to fifteen (15), to four (4). Additionally, the corrective actions on matching cases is reduced to a single action of replacing the C₄F₈ mass flow controller (MFC). Therefore, the service operator can elect to perform the corrective action by placing a request for the respective MS part, namely, a C₄F₈ mass flow controller; see FIG. 3H. Service activity data associated with the order of the MS part can be stored in the data storage system 20. The service activity data can, for example, include the MS part number, the quantity, the MS platform and its status, the MS tool and its status, the shipping information, the request information, the approval information, the service account, and the reason for replacement.

Referring now to FIG. 3I, the data action system 30 can indicate the MS parts associated with the current case. For example, the MS part source, the MS part, the MS part number (P/N), the MS part serial number (S/N), and the MS part status can be presented. For instance, the MS part status can include “Ordered”, “Paid”, “Shipped”, Installed”, or “Removed”. Once the MS part is requested, the MS part status can be amended, and proceed to indicate the MS part has “Shipped”, and has been “Paid” by a service account. On one end, a service operator is utilizing the activity management system to request a MS part, and on the other end another service operator is utilizing the activity management system to process the request including approving, shipping, etc. Additionally, once the MS part is received by the requestor, the shipping status can be changed to received, and the MS part serial number can be entered by the service operator. FIG. 31 also indicates the tests and corrective actions planned for the current case. For instance, the C₄F₈ mass flow controller is to be replaced.

As shown in FIG. 3J, when the service operator has received the requested MS part, and proceeds to replace the MS part on the MS tool, the service operator can obtain instructions for replacing the MS part that are specific to the MS part, specific to the MS tool, and specific to the MS platform. The corrective action procedures can be stored in the data storage system 20, and provided to the service operator via the data action system 30. For instance, FIG. 3J illustrates a corrective action procedure for replacing the C₄F₈ mass flow controller. The corrective procedure is specific to the MS part, specific to the MS tool, and specific to the MS platform.

Once the corrective action is completed, the activity management system is updated to reflect the changes; see FIG. 3K. For instance, the planned corrective action is moved to a completed corrective action, and the MS parts associated with the case are updated to show the removed MS part including MS part source, MS part, MS part number, MS part serial number, and MS part status. Thereafter, the service operator may proceed to re-check the tests which initially failed. For instance, in this case, the service operator re-checks test 51A5, and the C4F8 flow test. If the tests pass, as in this case, the activity management system is updated to reflect these additional tests, and test results. The MS part can then be decontaminated, and scrapped, if elected to do so.

Anywhere during this service process described as a first example, another service operator, such as a service supervisor, can monitor the progress of a specific case. For example, if the interactive case study is not performed, and MS parts are sporadically replaced (i.e., “shot-gunning approach), the service supervisor can affect the service activity by denying payment on an MS part, instructing the service operator requesting the MS part to follow the interactive case study, etc.

Alternatively, when utilizing the activity management system to perform an interactive case study, the service operator can obtain access to data available from the MS tool as a result of the local advanced process control (APC) software. For example, the MS tool can include an etch system, wherein historical data such as time traces of forward power, reflected power, pressure, and mass flow rate are available from each substrate run.

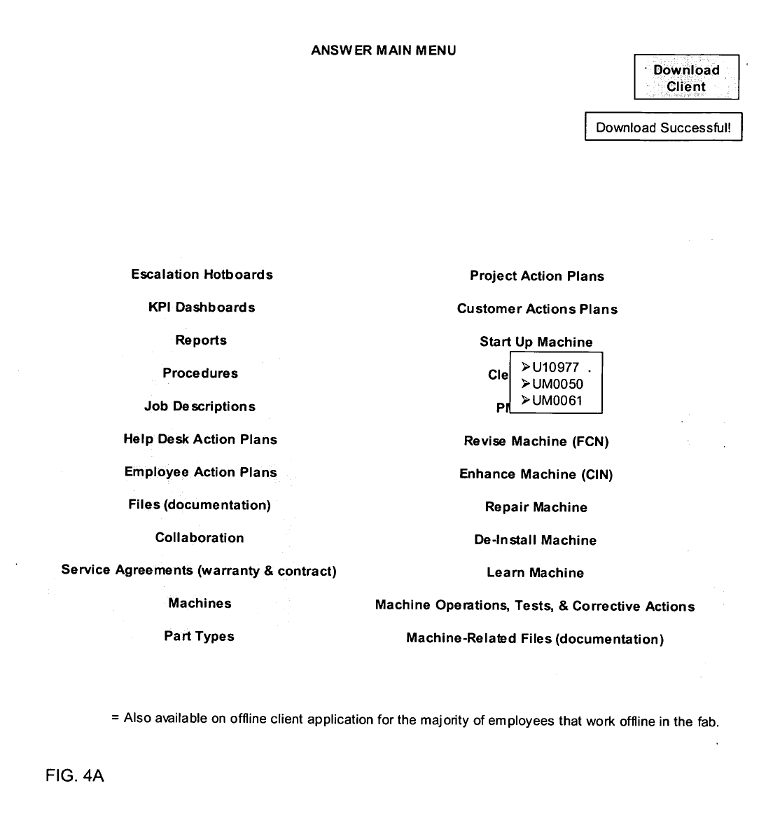

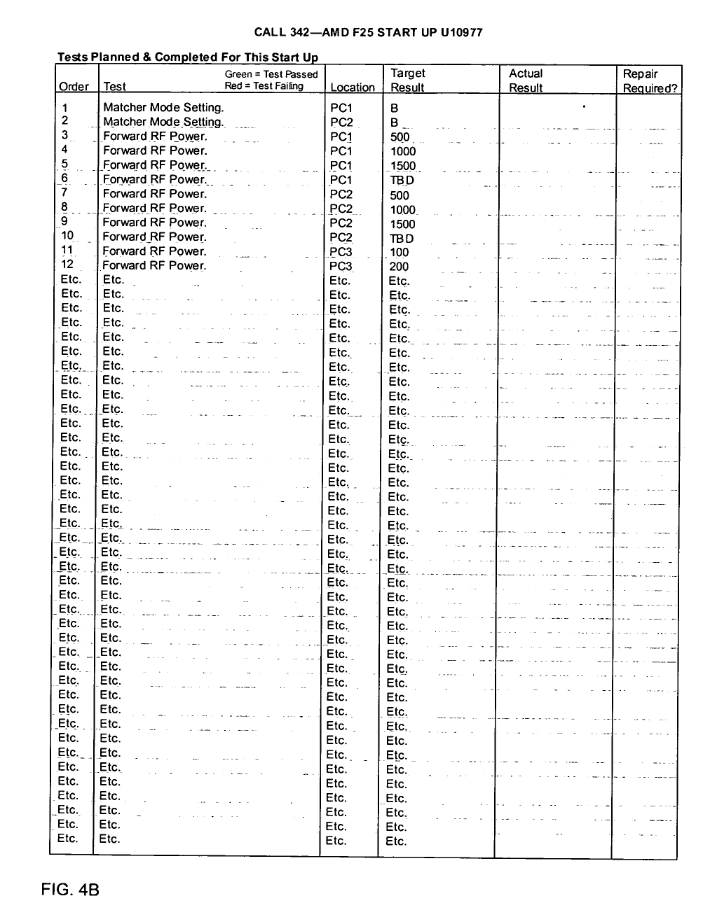

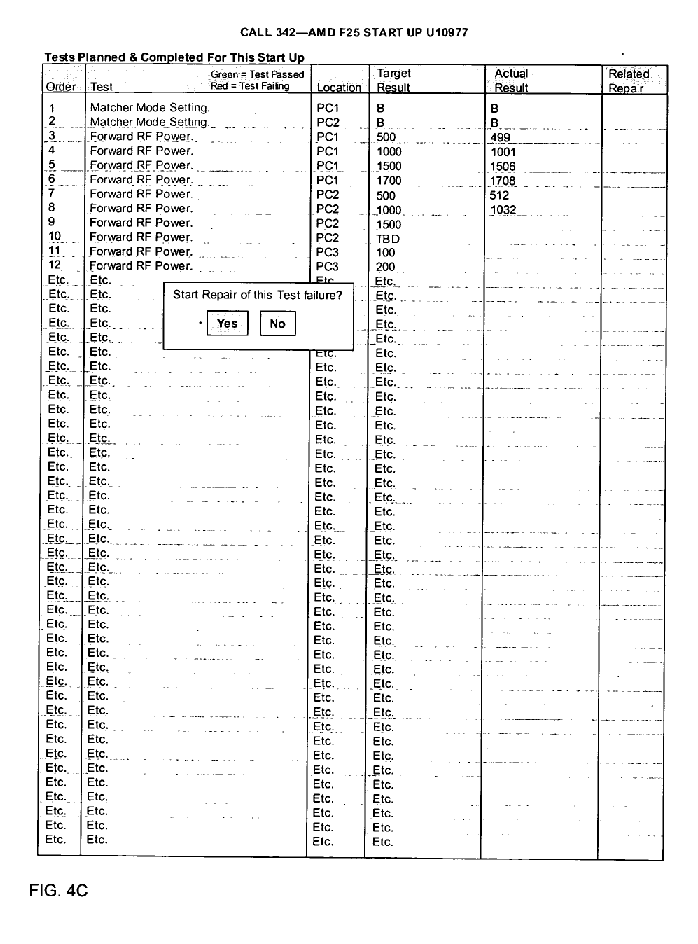

In another example, FIG. 4A illustrates an exemplary operator interface for performing a service component start-up using the activity management system, wherein the service component start-up function is accessed via the “Start Up Machine” key. In this example, the service operator has received a request from the activity management system to perform a start-up procedure for a MS tool. The MS tool can, as in this example, include a plasma processing system, such as an etch system, wherein the radio frequency (RF) generator and impedance match network require start-up tests to be performed. The service operator executes the activity management system, and selects the “Start Up Machine” key; see FIG. 4A.

Referring now to FIG. 4B, the activity management system can present a start-up list for testing a service component, such as a MS platform with one or more MS tools. The start-up procedure, as illustrated in FIG. 4B, can include a series of tests specific to the MS platform, the MS tool, the MS service agreement, etc. Furthermore, the start-up procedure can identify the test order, the test type (e.g., “Matcher Mode Setting”), the test location (e.g., MS tool number one, or Process Chamber 1 (PC1)), the target result of the test, the actual result of the test, and any related repair. The start-up procedure can be stored in the data storage system, wherein amendments can be made through the data collection system. Additionally, the data action system can provide the start-up procedure to the service operator to assist the service operator as illustrated in FIG. 4B.

When the start-up procedure is followed using the activity management system, the service operator can obtain test procedures for performing each test that is specific to the MS tool, and specific to the MS platform. Additionally, the service operator can access test specifications specific to the test performed for the specific MS platform, MS tool, MS service agreement, etc. The test specifications can, for example, define the upper and lower failure limits.

As tests are performed during the start-up procedure, the actual test result is entered via the data collection system, and the start-up procedure is updated to reflect these acquired results. If the actual result falls within the limits set by the target result plus or minus the upper and lower failure limits, respectively, then the test results in a “pass”. If the actual result does not fall within these limits, then the test results in a “fail”. For instance, as illustrated in FIG. 4C, a failure occurs when the forward RF power test is performed for the second MS tool (PC2), and the actual result exceeds the target result plus the upper failure limit. At this point, the service operator can continue to use the activity management system to troubleshoot the failure, as described above for repairing a MS tool. In this example, the service operator utilizes the activity management system to identify a corrective action, such as re-calibrating the RF generator. After performing this corrective action presented by the data action system, the test in the start-up test procedure is re-checked to ensure the test failure is corrected. Additionally, the start-up procedure is updated to reflect the corrective actions taken in the related repair field.

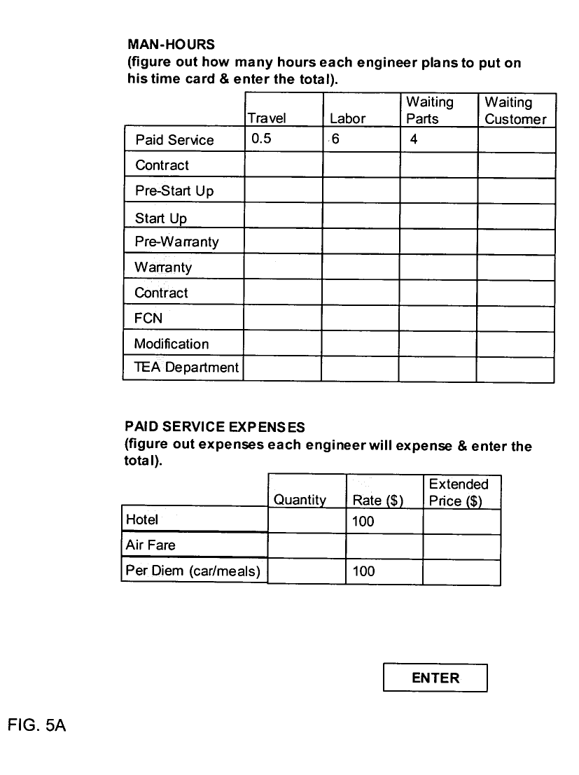

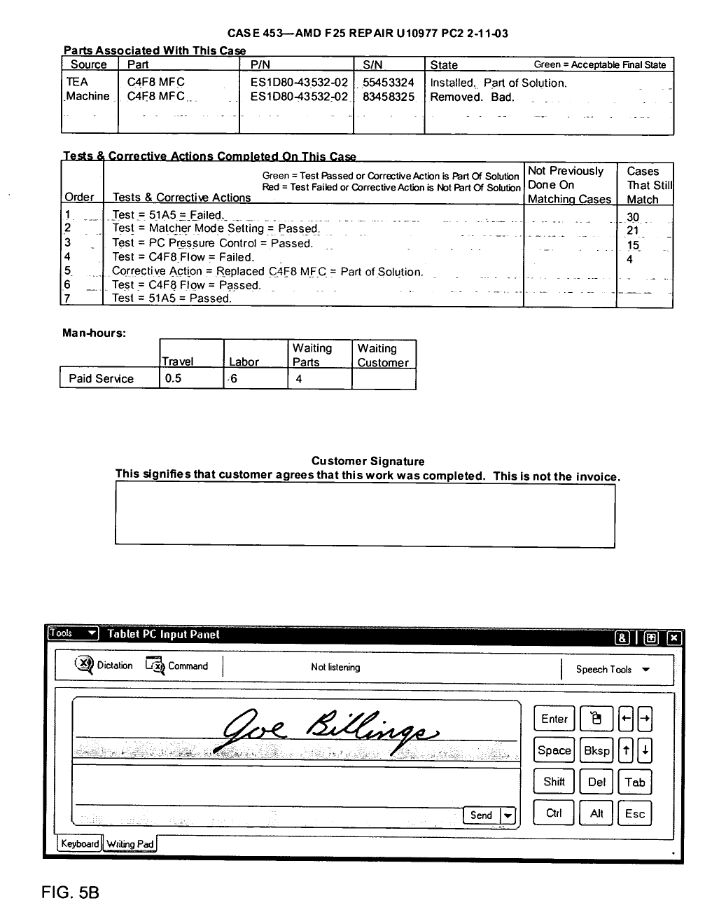

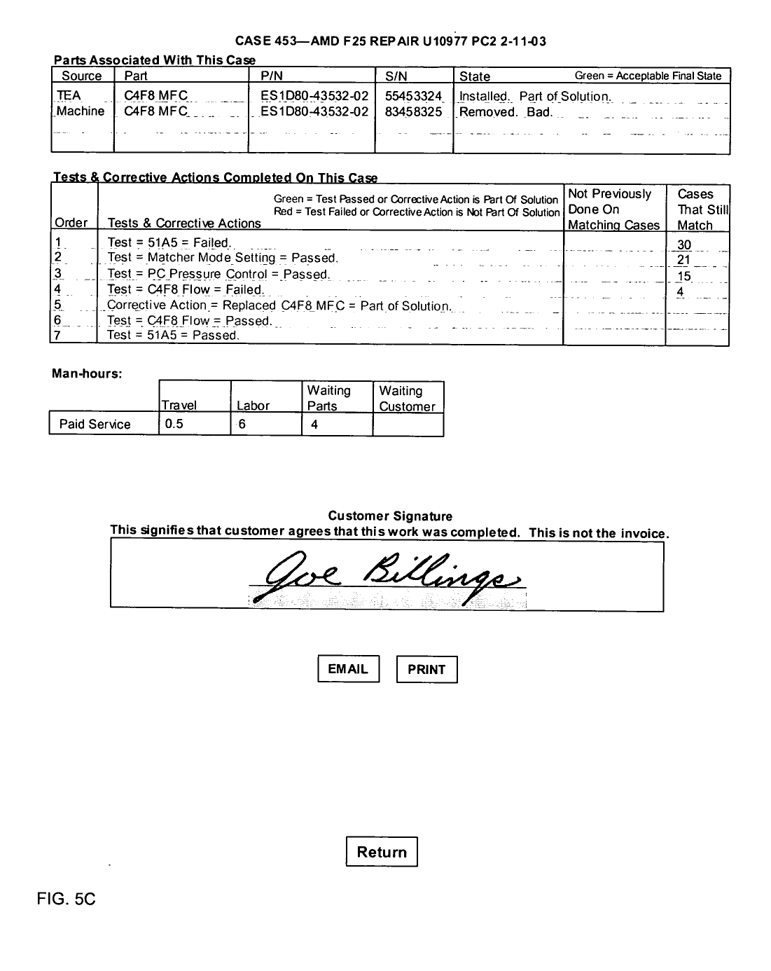

In yet another example (following the first example), the service operator can enter their expenses including time associated with travel, labor, waiting for MS parts, and waiting for the customer; see FIG. 5A. Furthermore, the time can be associated with different service accounts including paid service, service contract, pre-start up, start-up, pre-warranty, warranty, MS tool revision (FCN), MS tool enhancement (CIN), or equipment manufacturer department. Additionally, paid service expenses can be entered including hotel, airfare, and per diem (auto/meals). For instance, the service operator enters the time, or cost, or both into the fields. Once acquired by the data collection system, the service activity data can be stored in the data storage system. As illustrated in FIGS. 5B and 5C, a customer can verify that the service as indicated by the service operator were completed. This verification can, for example, be printed, and submitted to the equipment manufacturer via regular mail or electronic mail as shown in FIG. 5C.

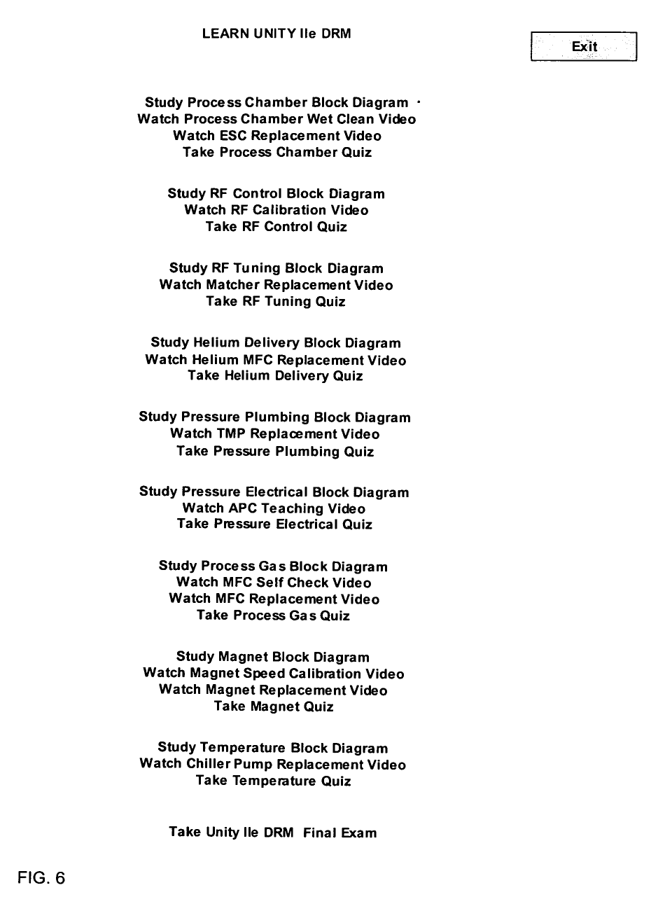

In yet another example, a service operator can access service educational materials specific to a MS platform, a MS tool, a MS part, a MS service agreement, etc. For example, the service operator can gain access through the activity management system using the GUI, and selecting the “Learn Machine” key. The service operator can identify the MS platform, or MS tool, or MS part, or MS service agreement, or any combination thereof. Thereafter, the service operator can gain access to mechanical diagrams, electrical diagrams, training videos, training procedures, product descriptions, etc. A service operator, such as a service supervisor, can generate one or more exams for the educational materials using the activity data management system. The exams can include an answer key. Furthermore, a service operator can take an exam following the training material in order to evaluate their level of understanding. For example, FIG. 6 illustrates a series of training data stored in the data storage system for a Unity IIe (MS platform), DRM (MS tool) etch system.

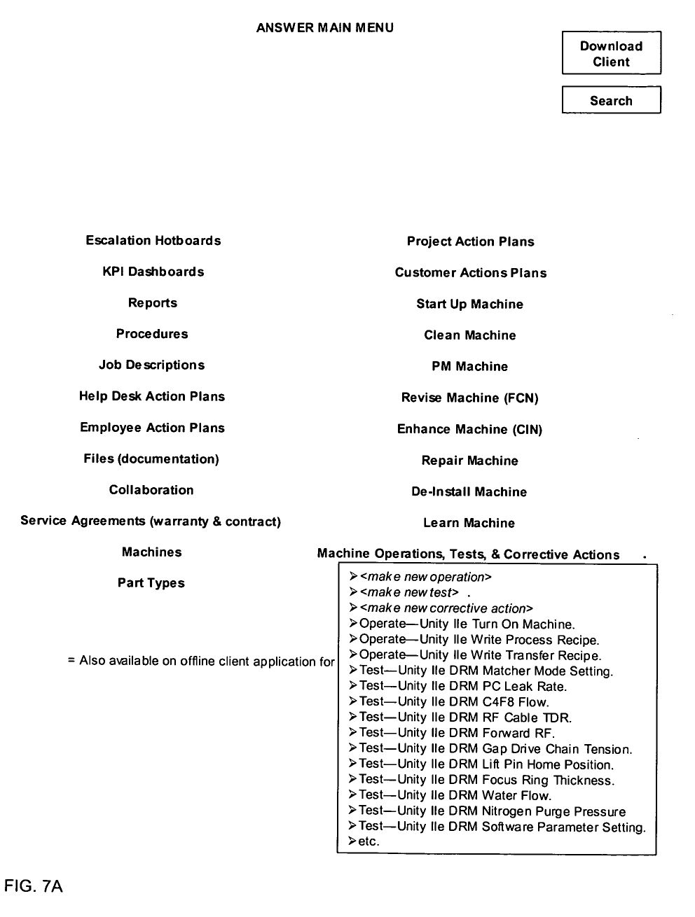

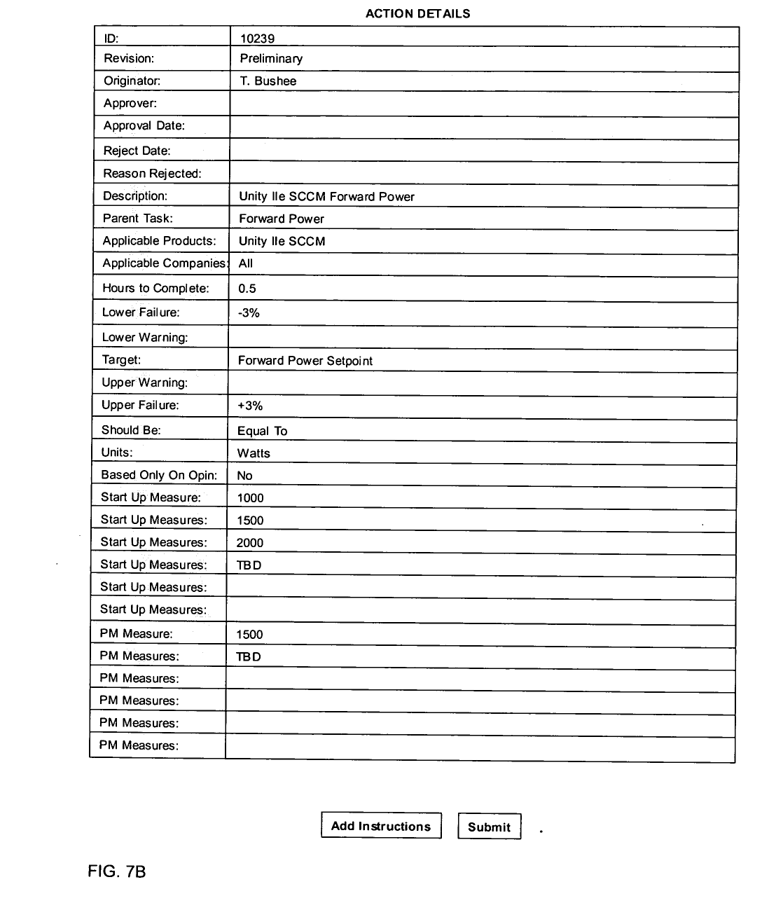

In yet another example, a service operator can integrate a new test or corrective action, and amend a current test or corrective action, using the “Machine Operations, Tests, & Corrective Actions” key in the GUI; see FIG. 7A. As shown in FIG. 7A, the service operator can make a new operation, make a new test, and make a new corrective action, as well as amend an existing operation, test, or corrective action. For instance, FIG. 7B illustrates the process by which a service operator enters a new test. The test entry can include an identification (ID) number, a revision status, an identification of the originator, an identification of the approver, an approval date, a rejection date, a reason for rejecting the new test, a description of the new test (e.g., an identification of the MS platform, MS tool, test parameter, etc.), an identification of the parent task, an identification of applicable products (e.g., MS platform, MS tool, etc.), an identification of the applicable companies, an estimated time to complete the new test, a lower failure limit, a lower warning limit, a target result, an upper failure limit, an upper warning limit, an identification of the mathematical operator to compare target and actual results (e.g., “equal to”), an identification of the units of measurement, an indication of whether the results are based upon opinion or not, one or more test values to measure during start-up, and one or more test values to measure during preventative maintenance. Once the new test is entered, it may be submitted for approval. For example, the new test can be sent to another service operator, such as a supervisor, via regular mail, or electronic mail. Additionally, upon completing the new test, the service operator can enter one or more test procedures for the new test, wherein each test procedure can be specific to a MS platform, MS tool, MS part, etc.

Furthermore, a service operator can amend a current test or corrective action using the “Machine Operations, Tests, & Corrective Actions” key in GUI 100. The service operator can enter a new revision number, make changes to certain test conditions, and submit the amended test for approval.

In yet another example, a service operator can access documentation specific to a MS platform, MS tool, MS part, or MS service agreement. For example, the service operator can gain access through the activity management system using the GUI, and selecting the “Machine-Related Files (documentation)” key.

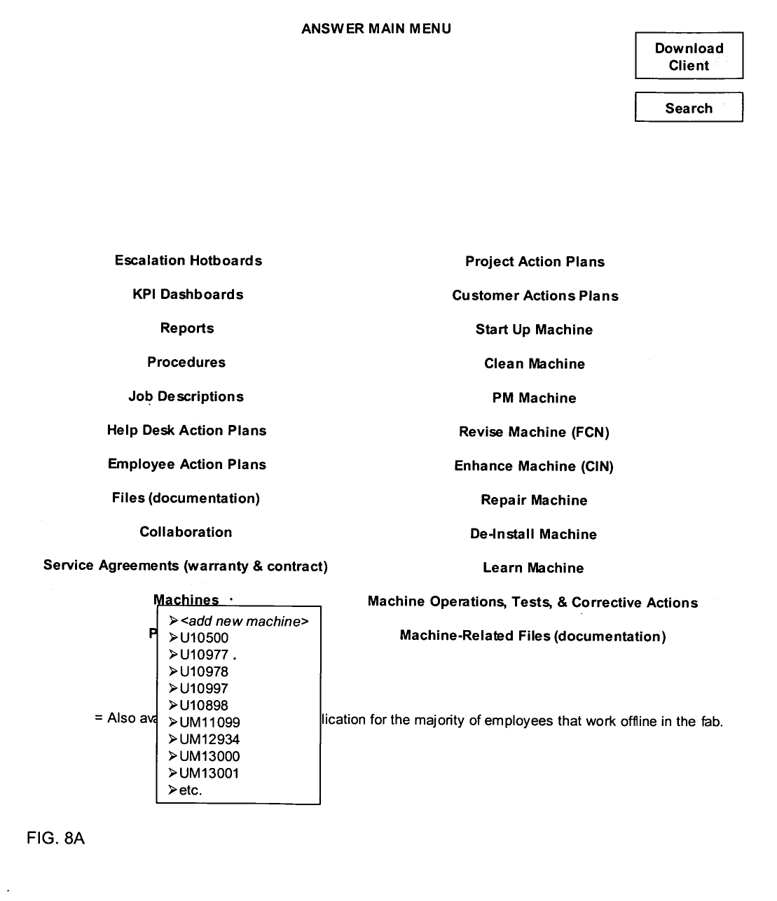

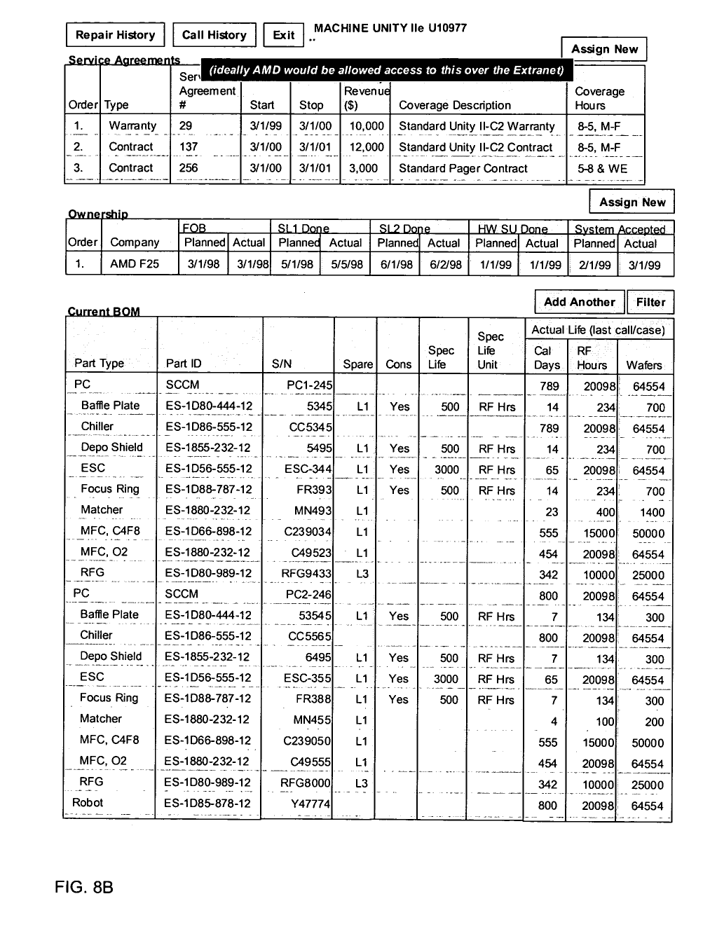

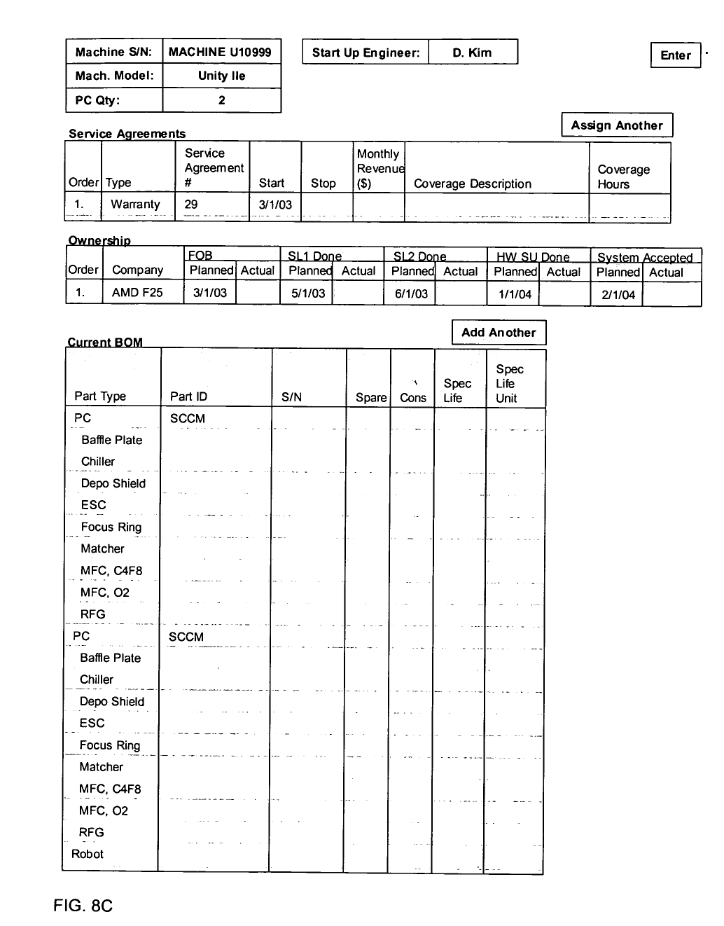

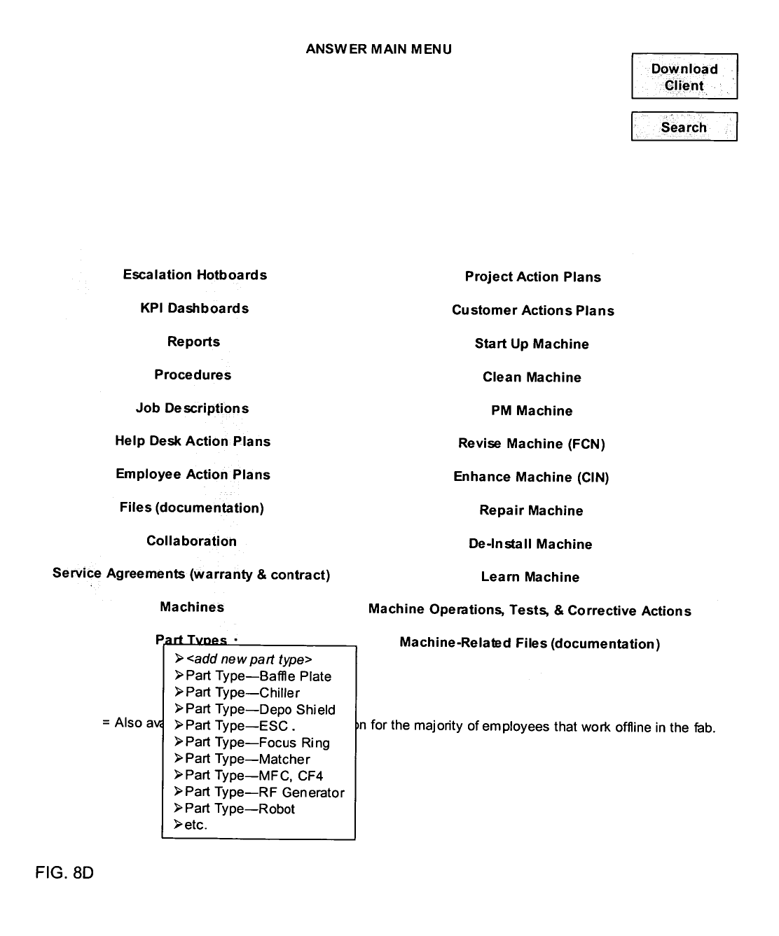

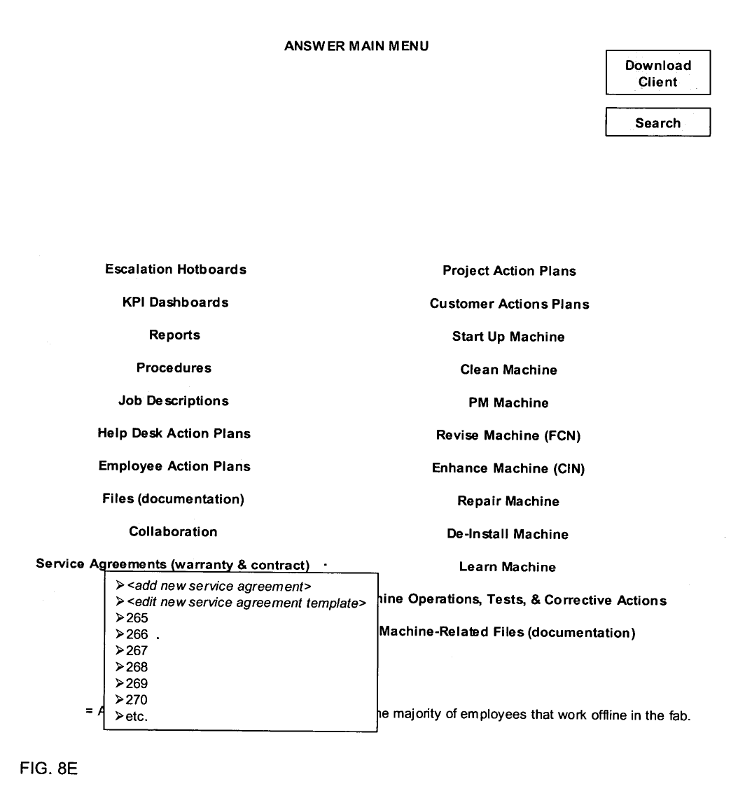

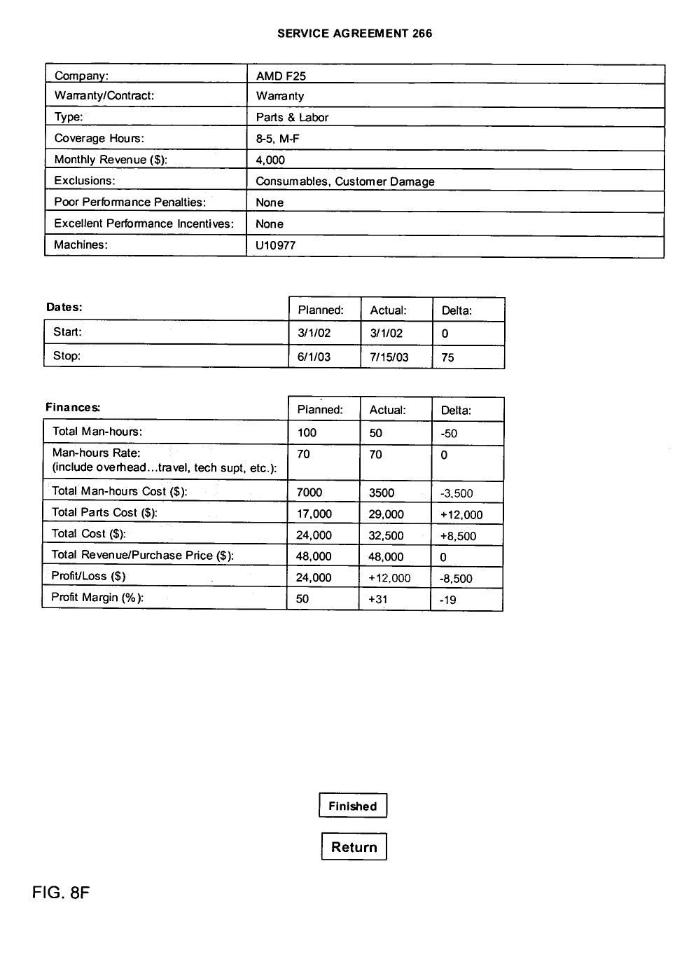

In yet another example, a service operator can add a new MS platform and MS tool to the activity management system, or review the service activity data associated with an existing MS platform and MS tool by using the “Machines” key in the GUI; see FIG. 8A. As illustrated in FIG. 8B, an existing MS platform (e.g., Unity IIe) and an existing MS tool (e.g. SCCM No. U10977) can be selected, and the service activity data can be reviewed. The service activity data can include service accounts (agreements), ownership information (customer information), and a current bill-of-materials (BOM). For instance, the service account data can include an order number, a service account type (e.g., warranty, contract, etc.), a service agreement number, a service starting date, a service stopping date, a monthly revenue, a service account coverage description, and service coverage hours. Therein, new service accounts can be assigned. Additionally, for instance, the ownership information can include an order number, company (customer) name, FOB planned and actual dates, SL1 planned and actual dates, SL2 planned and actual dates, HW SU planned and actual dates, and system acceptance planned and actual dates. Therein, new ownership information can be entered. Additionally, for instance, the current BOM can include a list of MS parts, MS part numbers, MS part serial numbers, spare indicators (whether or not MS part spare is available), consumable indicators (whether or not MS part is a consumable or not), and specified lifetimes, units of specified lifetime (e.g., hours, etc.), as well as actual data. The actual data can include number of days since calibration of the MS part, the number of radio frequency (RF) hours associated with the MS part, and the number of substrates (wafers) executed for the MS part. Therein, another MS part can be added to the current list.

As illustrated in FIG. 8C, a service operator can add a new MS platform and MS tool to the activity management system by using the “Machines” key in the GUI. Therein, the service operator can enter the MS platform serial number, the MS platform, and the number of MS tools coupled to the MS platform. Additionally, the service operator can enter data associated with the service account (agreement), and the ownership. Furthermore, the service operator can enter the current BOM including MS tool and MS part identification, MS part ID numbers, MS part serial numbers (once received from MS tool shipping), and MS part specifications. During the addition of the new MS platform data, the service operator can identify themselves by name. Alternately, when the service enters the MS tool into the BOM, the MS parts can auto-fill the list if known to relate to the specific MS tool.

In yet another example, a service operator can add new MS parts, or amend existing MS parts by using the GUI, and selecting the “Part Types” key; see FIG. 8D.

In yet another example, a service operator can add or edit a new MS service agreement, or amend an existing MS service agreement by using the GUI, and selecting the “Service Agreements (warranty & contract)” key; see FIG. 8E. As illustrated in FIG. 8F, the service operator can enter company (customer) information, a MS service agreement (contract or warranty) number, a service agreement type, service agreement coverage hours (e.g., 8AM-5PM, M through F), monthly revenue, service agreement exclusions (e.g., consumables, customer damage, etc.), poor performance penalties, excellent performance incentives, and MS platform and/or MS tool information. Additionally, the planned and actual start and stop dates for the service agreement can be entered, as well as the difference between the planned and actual values. Additionally, the service operator can enter the planned and actual service agreement finances including total man-hours, man-hours rate, total man-hours cost, total MS parts cost, total cost, total revenue (purchase price), profits (+), losses (−), and profit margin (%).

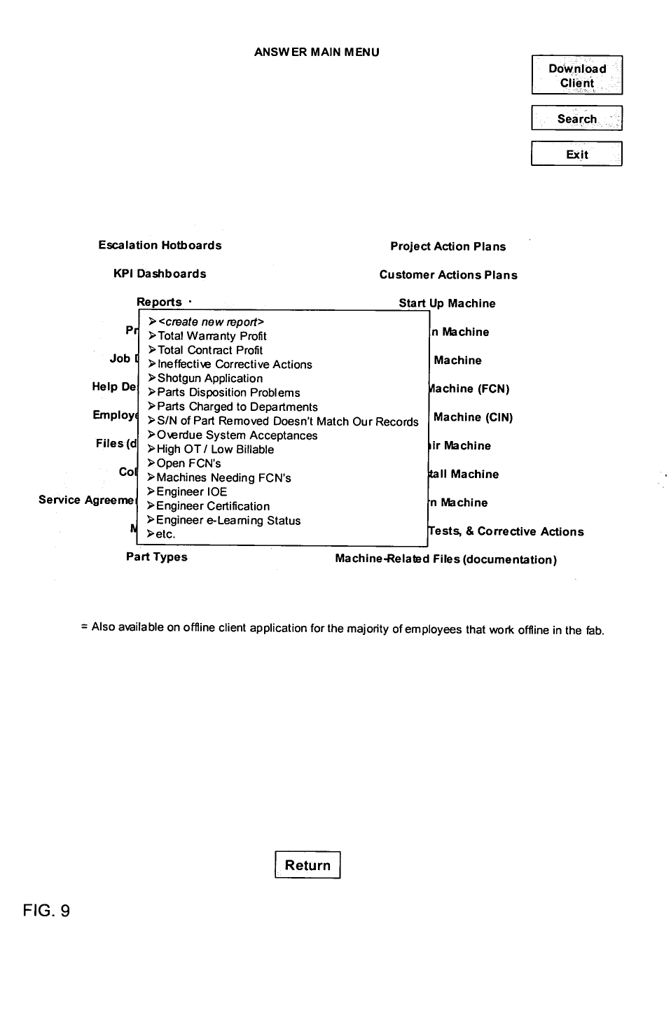

In yet another example, a service operator can access service activity data in the data storage system, and the data action system can prepare a report of the requested data for the service operator. As shown in FIG. 9, the service operator can create a new report, or generate a specific type of report including, for example, a total warranty profit report, a total contract profit report, an ineffective corrective actions report, a shot-gun application report, a parts disposition problems report, a parts charged to departments report, a serial number (S/N) of part removed doesn't match our records report, an overdue system acceptances report, a high overtime (OT)/billable hours report, an open FCN report, a machine needing FCN report, an engineer IOE report, an engineer certification report, an engineer e-learning report, etc.

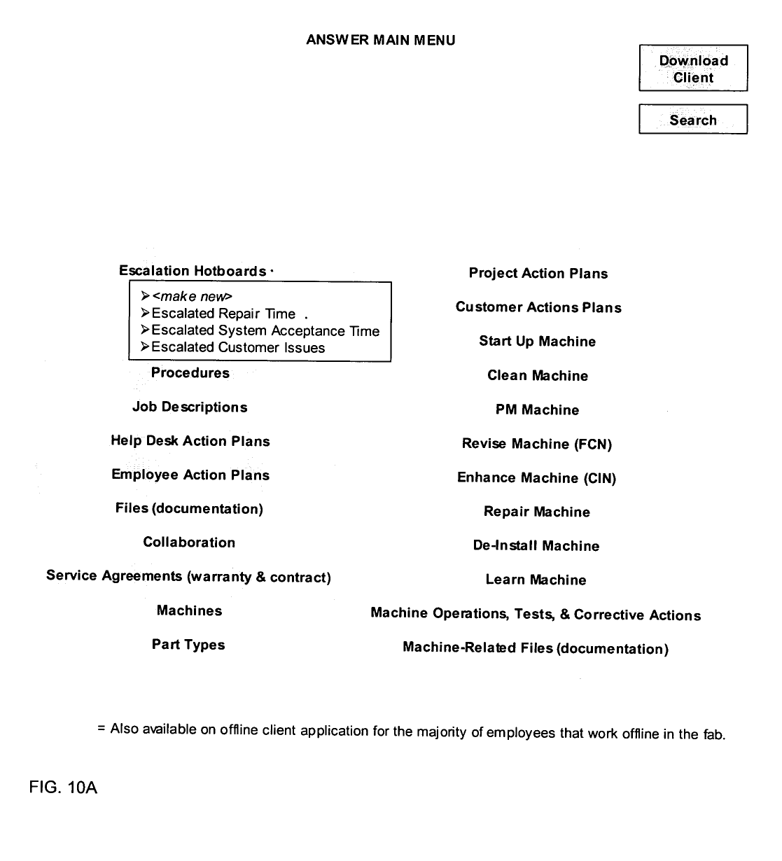

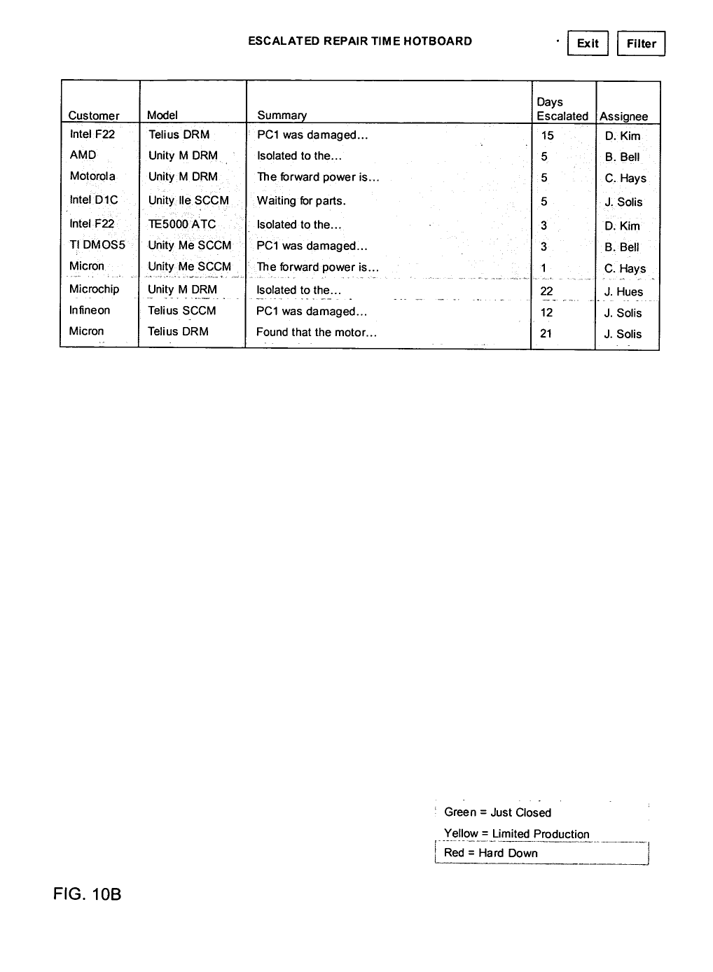

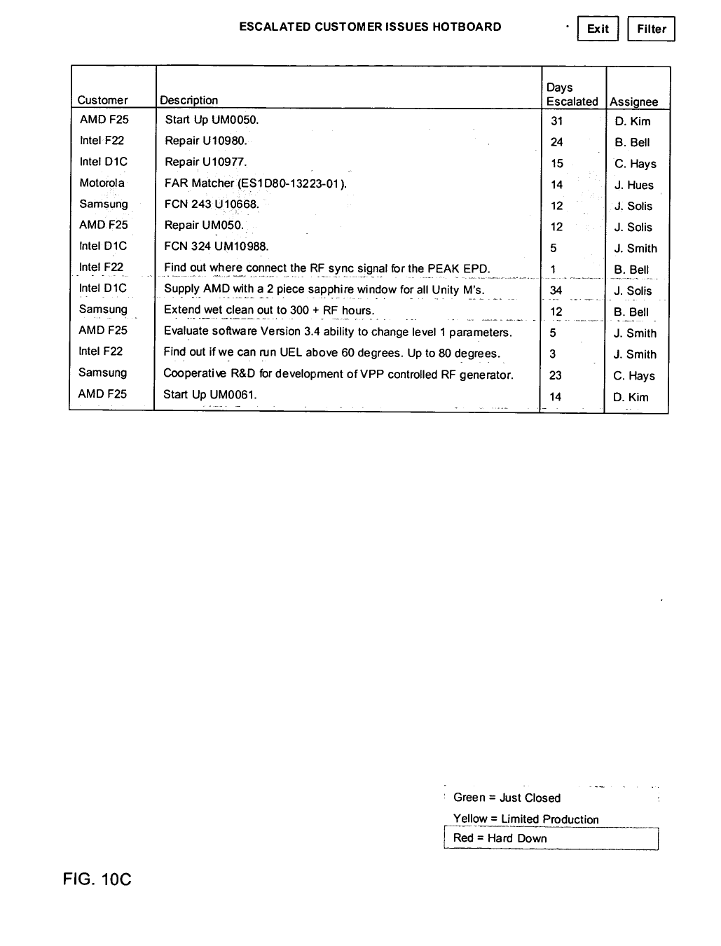

In yet another example, a service operator can create a new escalation hot-board, or review an escalated repair time, an escalated system acceptance time, or an escalated customer issue. As shown in FIG. 10A, the service operator can access escalation hot-boards through the GUI using the “Escalation Hotboards” key. For example, FIG. 10B illustrates an escalation time hot-board, wherein the customer (or manufacturing facility) can be identified, an MS platform and MS tool can be identified (“Model”), a summary of the repair status, a number of days the repair has been escalated, and an identification of a service operator assigned to the repair. Additionally, for instance, the hot-board items can be color coded in order to further identify their status (i.e., red=hard down; yellow=limited production; and green=just closed). Furthermore, as illustrated in FIG. 10C, an escalation customer issues hot-board can be accessed.

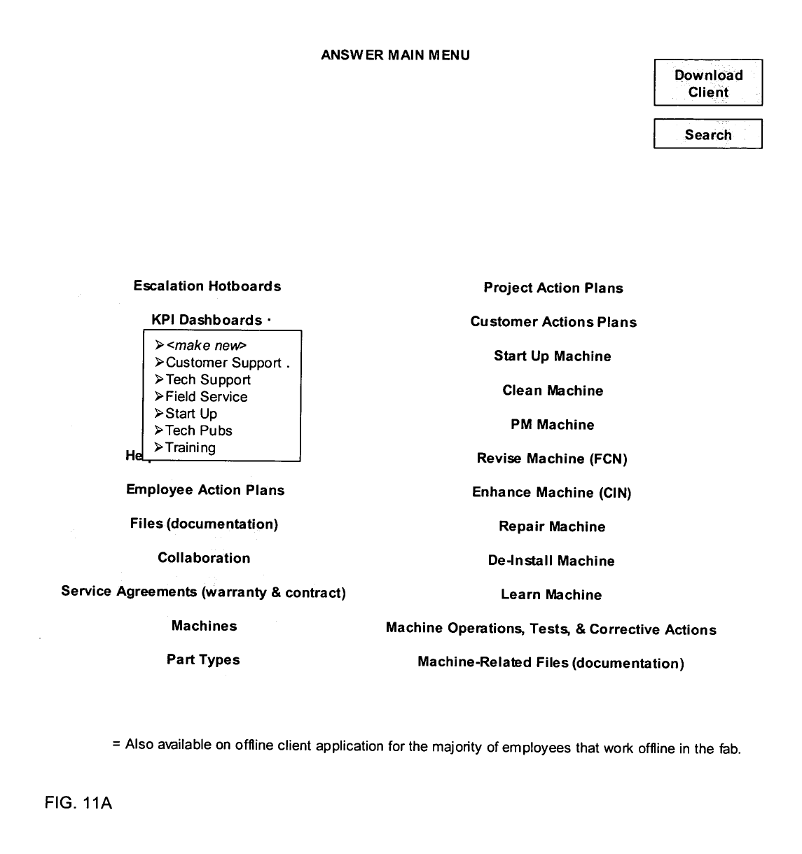

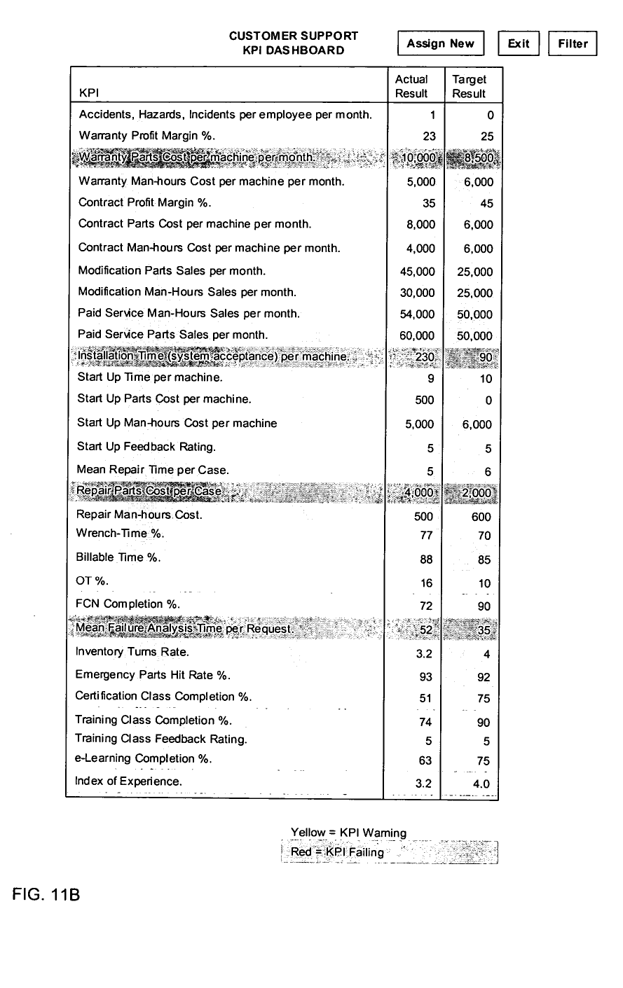

In yet another example, a service operator can create a new key point indicator (KPI) dash-board for a service activity, or access an existing KPI dash-board for customer support, technical support, field service, start-up, technical publications, or training. As shown in FIG. 11A, the service operator ca access KPI dash-boards through GUI using the “KPI Dashboards” key. For example, FIG. 11B illustrates a customer support KPI dash-board. The dash-board presents the KPI, as well as the actual result and target result. For instance, the KPI may include the actual result and target result for the monthly costs associated with warranty MS parts on a specific MAS platform and MS tool. In this case, the actual result of $10,000 exceeds the target result of $8,500. Additionally, for instance, the dash-board items can be color coded in order to further identify their status (i.e., red=KPI failing; yellow=KPI warning). When the actual result exceeds the target result, then a “KPI warning” may be issued. When the actual result exceeds the target result by a pre-determined margin, then a “KPI failing” may be issued.

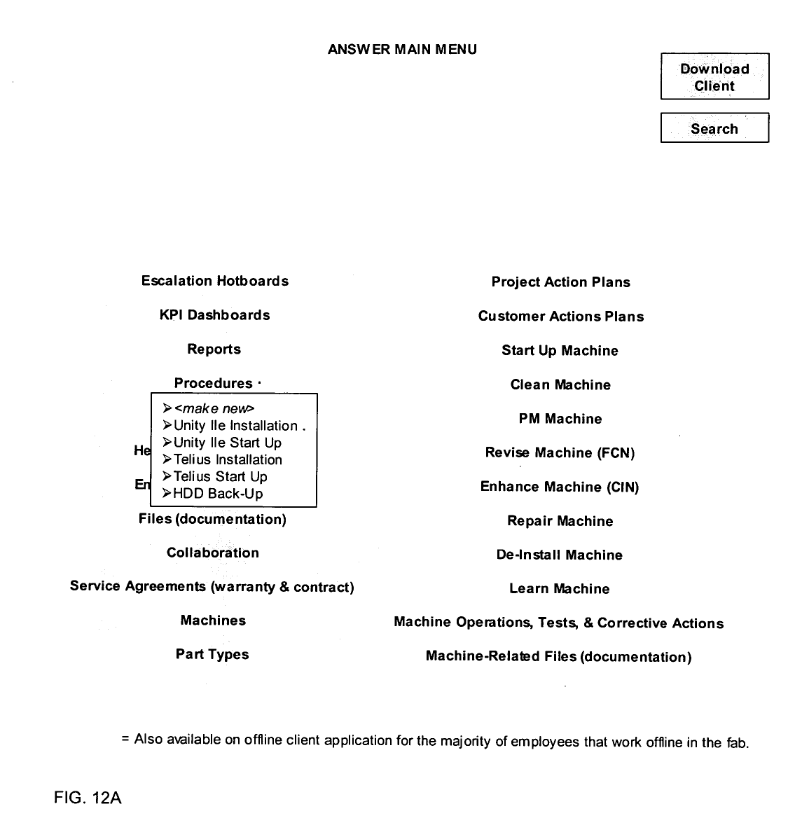

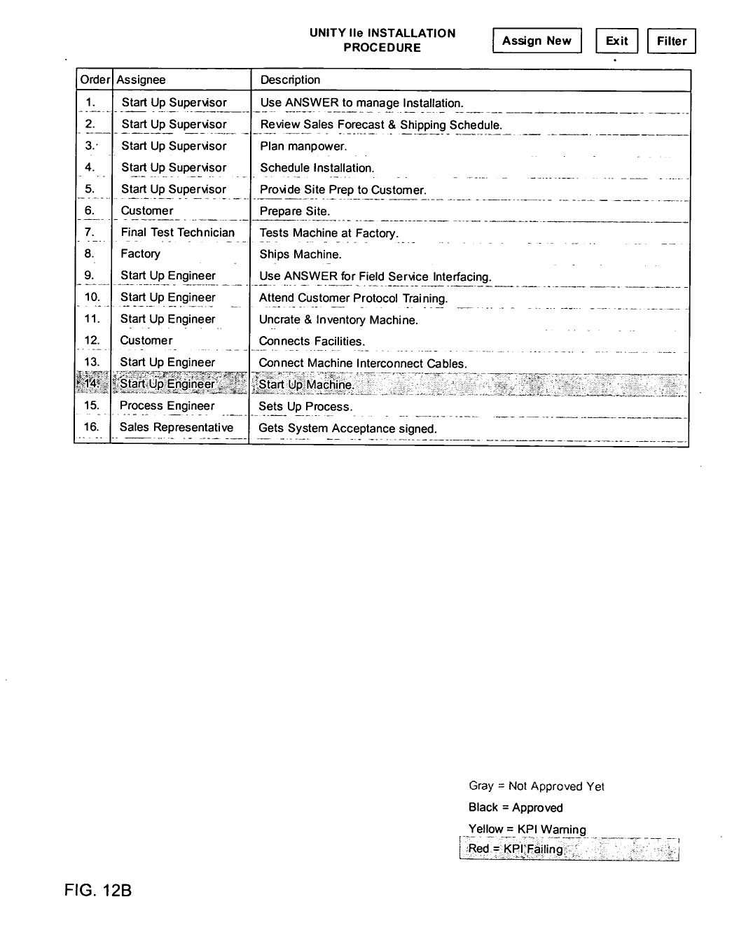

In yet another example, a service operator can access procedures for performing a service activity, and determine his or her responsibility for each step in the procedure. As shown in FIG. 12A, the service operator can access the procedures through the GUI using the “Procedures” key. For example, the service operator can create a new procedure, or review an existing procedure. FIG. 12B illustrates an exemplary procedure for a Unity IIe installation. The procedure can include the order of the steps in the procedure, the service operator to whom the step is assigned (e.g., “Start Up Supervisor” versus “Start Up Engineer”), and the description of the procedure step.

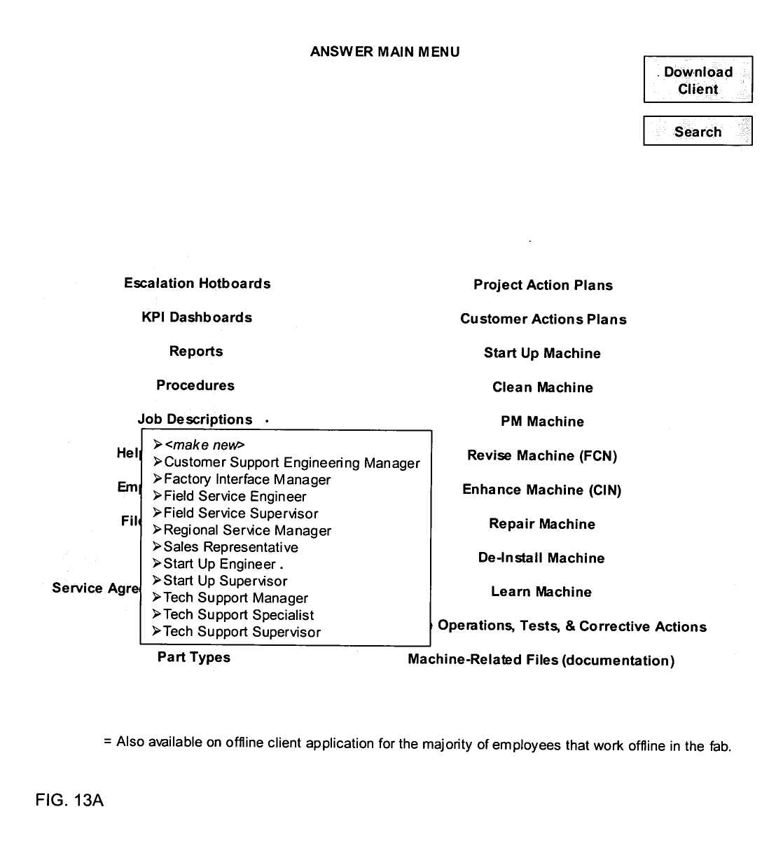

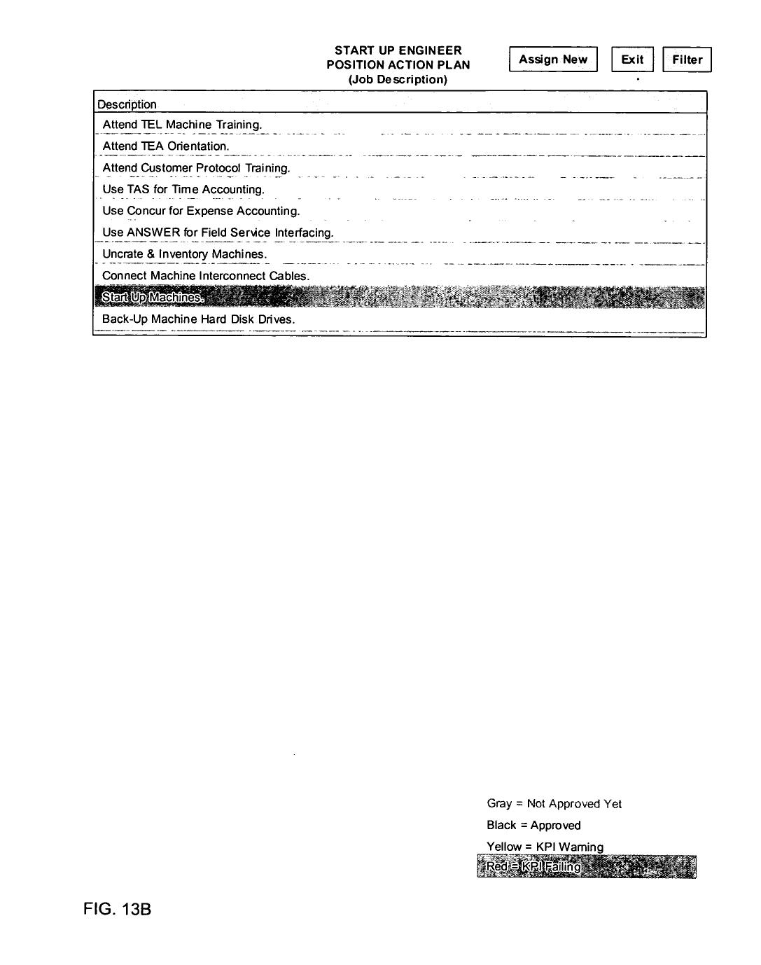

In yet another example, a service operator can access job descriptions for service operators, and determine his or her job responsibilities. As shown in FIG. 13A, the service operator can access the job descriptions through the GUI using the “Job descriptions” key. For example, the service operator can create a new job description, or review an existing job description. FIG. 13B illustrates an exemplary job description for a Start Up Engineer.

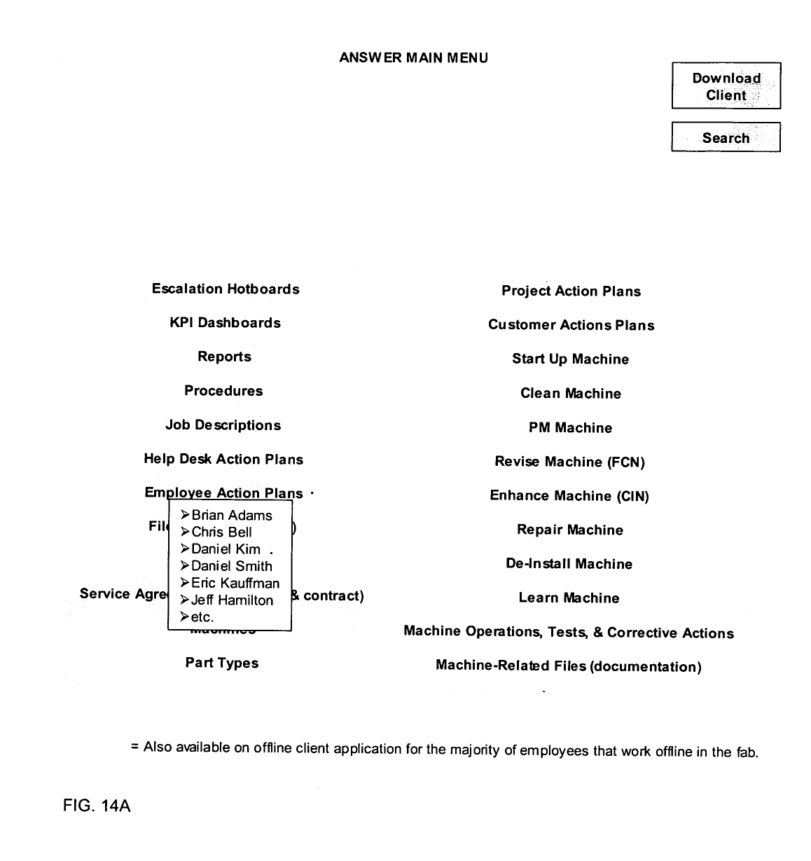

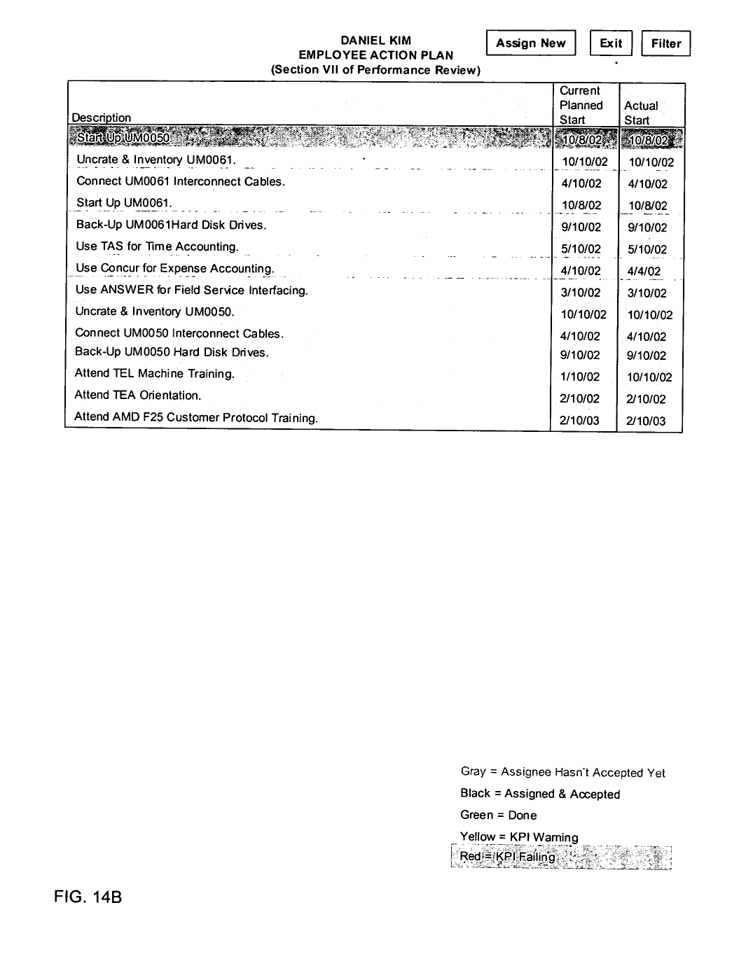

In yet another example, a service operator can access employee action plans, and determine their service action responsibilities. As shown in FIG. 14A, the service operator can access employee actions through the GUI using the “Employee Action Plans” key. For example, as illustrated in FIG. 14B, the service operator can review a list of service actions including a description of the action, an indication of the current planned start date, and an indication of the actual start date. Furthermore, the service actions can be color coded in order to present their status (e.g., gray=assignee has not accepted the service action; black=service action assigned and accepted; green=service action completed; yellow=service action generating KPI warning; red=service action generating KPI failure).

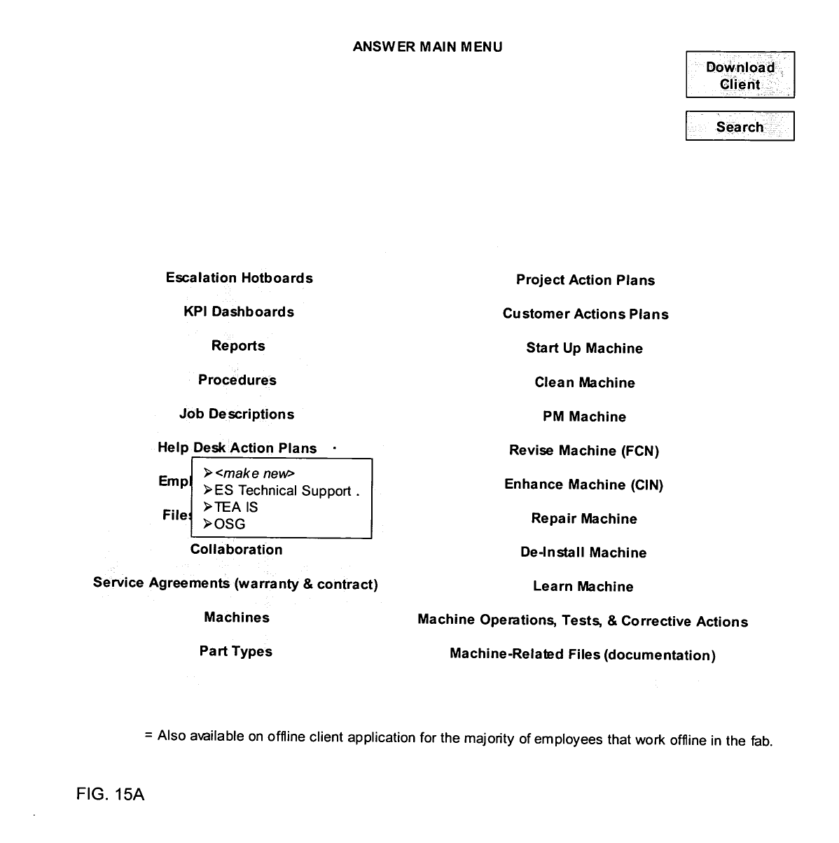

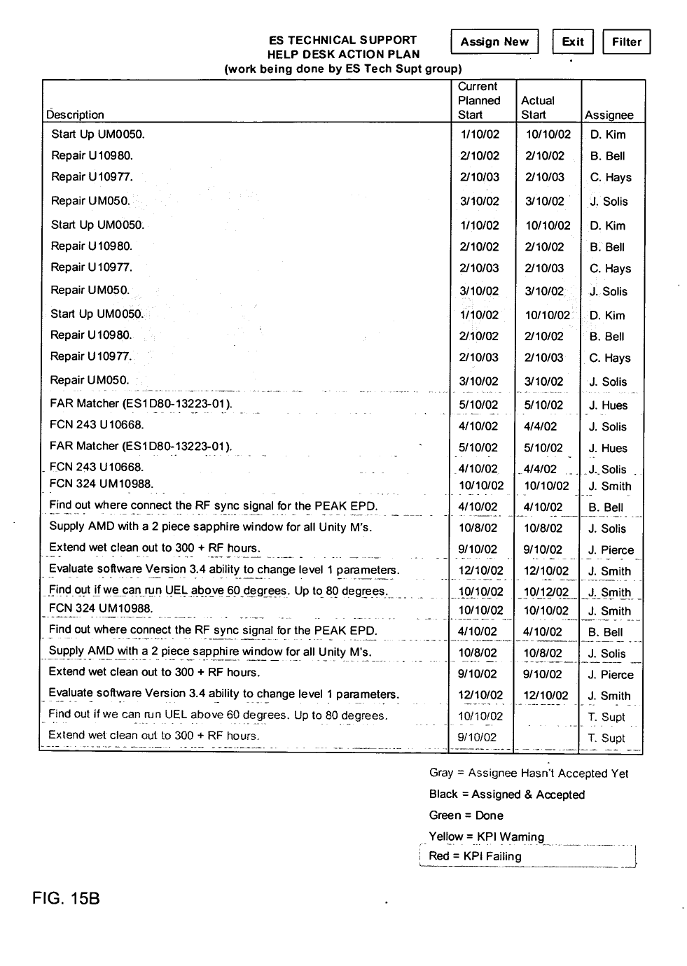

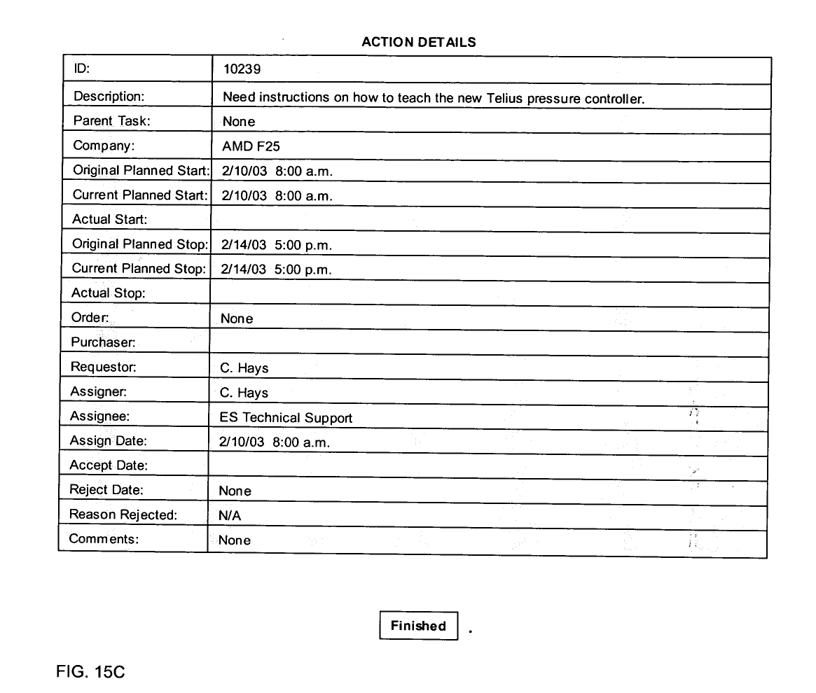

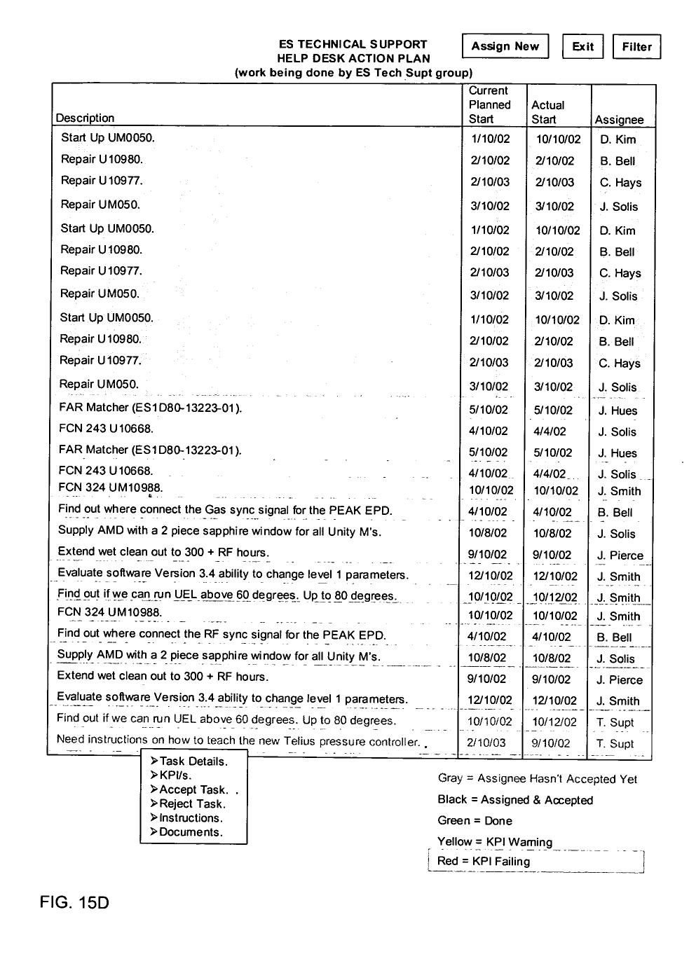

In yet another example, a service operator can access help desk action plans, and determine their service action responsibilities as a result of the help desk function. As shown in FIG. 15A, the service operator can access employee actions through the GUI using the “Help Desk Action Plans” key. For example, as illustrated in FIG. 15B, the service operator can review a list of service actions including a description of the action, an indication of the current planned start date, an indication of the actual start date, and an indication of the service operator to whom the service action has been assigned. Furthermore, the service actions can be color coded in order to present their status (e.g., gray=assignee has not accepted the service action; black=service action assigned and accepted; green=service action completed; yellow=service action generating KPI warning; red=service action generating KPI failure).

Additionally, a service operator can request help using the “Help Desk Action” function. For instance, the service operator can select “ES Technical Support (see FIG. 15A), and access the service actions being performed by the ES Technical Support Group. Thereafter, the service operator can assign a new service action using the “Assign New” key (see FIG. 15B), and enter the service action details. As shown in FIG. 15C, the service action details can include an action identification number (ID), a description of the service action, an identification of a parent action (or task) if it exists, an identification of the customer (or company), an indication of the original planned starting date and time, an indication of the current planned starting date and time, an indication of the actual start date and time, an indication of the original planned stopping date and time, an indication of the current planned stopping date and time, an indication of the actual stop date and time, an indication of the order of the service action, an indication of the purchaser, an identification of the requester, an identification of the assignor, an identification of the assignee, an assignment date, an acceptance date, a rejection date, a reason for rejection, and comments. Once the action details are entered, the service operator can add the service action request to the list of service actions, such as the list in FIG. 15B. The new service action can be highlighted gray to indicate it has not been accepted. The activity management system can notify ES Technical Support (via, for example, electronic mail) that a new service action has been added. Another service operator, informed of the new service action can decide to accept the service action request (see FIG. 15D), and the list of service actions (FIG. 15B) is updated to reflect the change in status of this particular service action by highlighting the action black (as accepted). As illustrated in FIG. 15D, the service operator can, alternatively, reject the service action, review the KPIs, review the instructions, review the service action details, or review any supporting documents.

Furthermore, using the GUI and the “Help Desk Action” key, the service operator can forward the service action from, for example, the ES Technical Support Group to another group, such as the TEA IS Group. The service operator can stop the service action in the first group, and initiate a request in a second group.

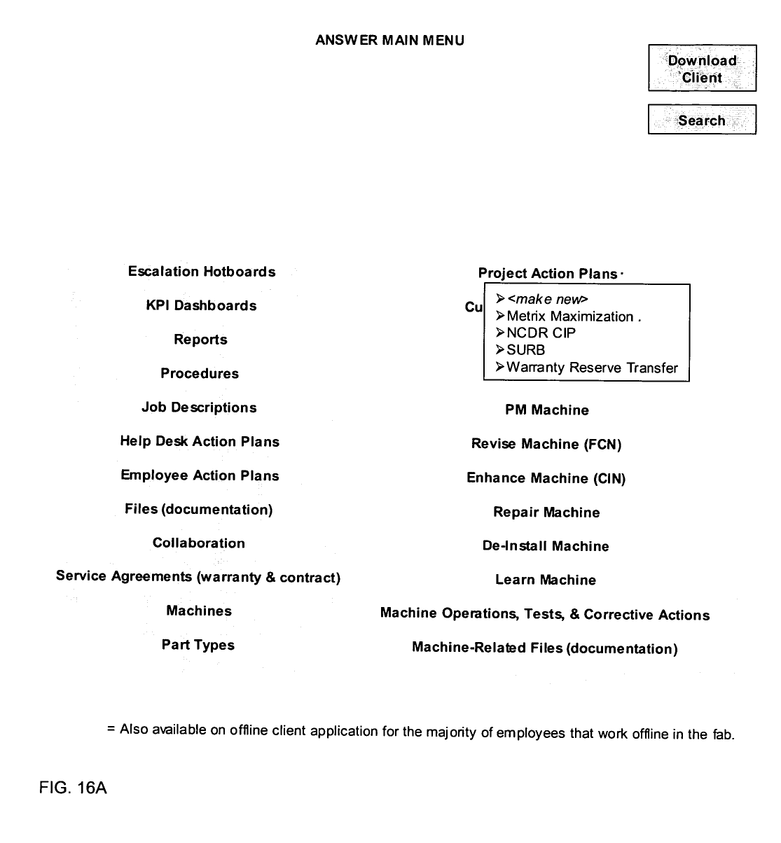

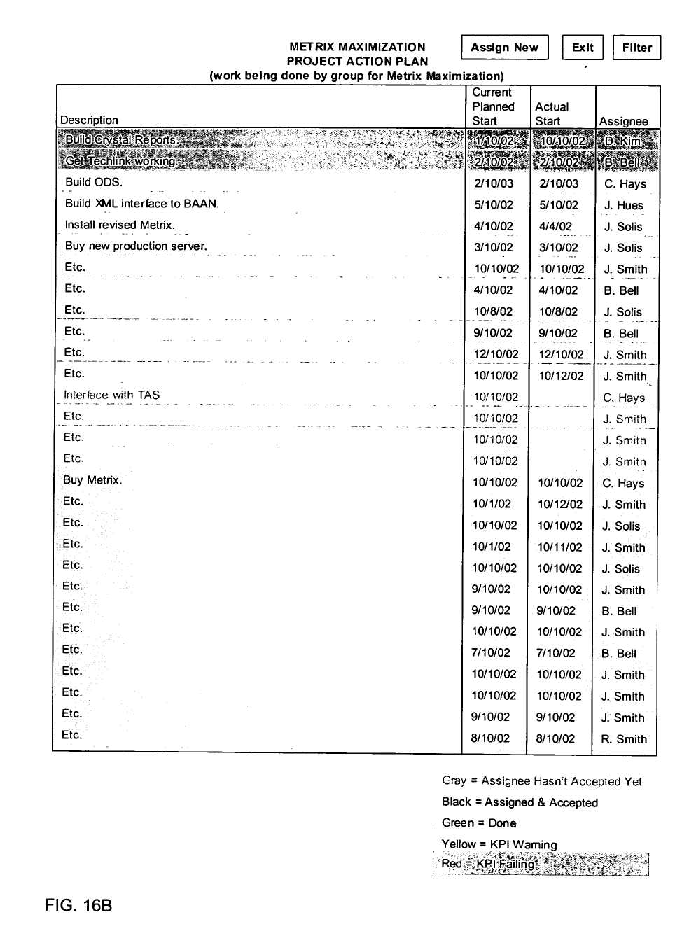

In yet another example, a service operator can access project action plans, and determine their service action responsibilities for the specific project. As shown in FIG. 16A, the service operator can access employee actions through the GUI using the “Project Action Plans” key. For example, as illustrated in FIG. 16B, the service operator can review a list of service actions including a description of the action, an indication of the current planned start date, an indication of the actual start date, and an indication of the service operator to whom the service action has been assigned. Furthermore, the service actions can be color coded in order to present their status (e.g., gray=assignee has not accepted the service action; black=service action assigned and accepted; green=service action completed; yellow=service action generating KPI warning; red=service action generating KPI failure).

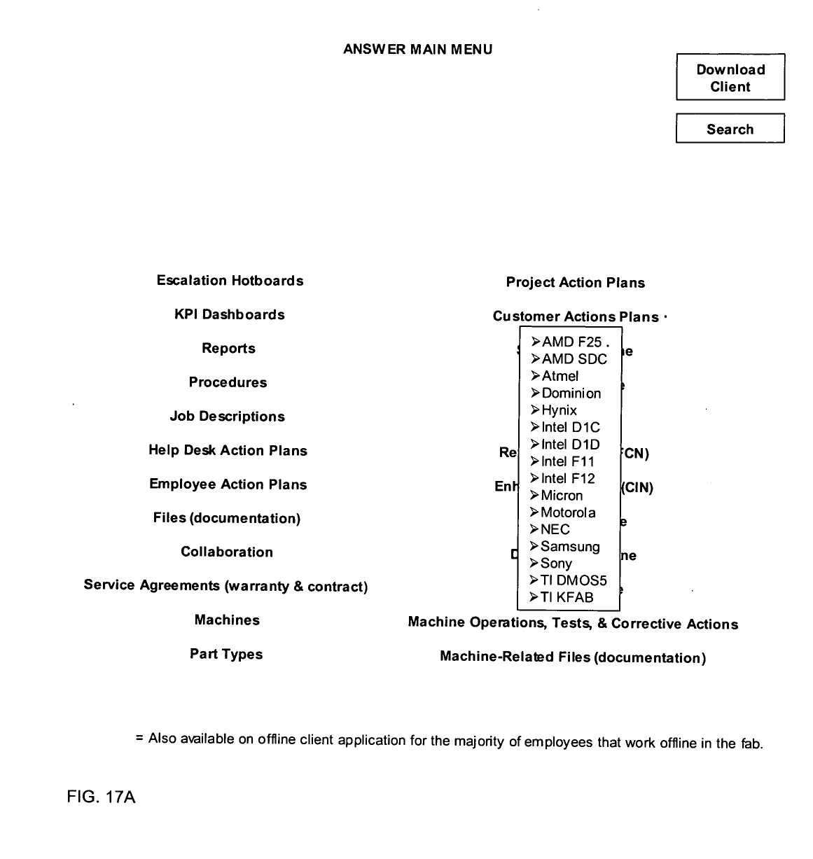

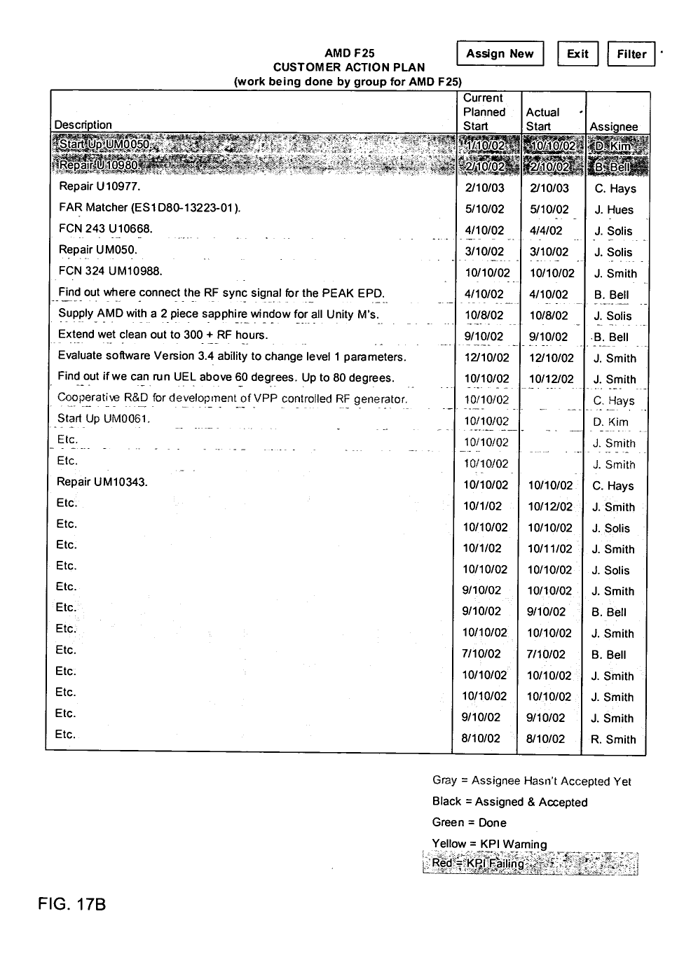

In yet another example, a service operator can access customer action plans, and determine their service action responsibilities for the specific customer. As shown in FIG. 17A, the service operator can access employee actions through the GUI using the “Customer Action Plans” key. For example, as illustrated in FIG. 17B, the service operator can review a list of service actions including a description of the action, an indication of the current planned start date, an indication of the actual start date, and an indication of the service operator to whom the service action has been assigned. Furthermore, the service actions can be color coded in order to present their status (e.g., gray=assignee has not accepted the service action; black=service action assigned and accepted; green=service action completed; yellow=service action generating KPI warning; red=service action generating KPI failure).

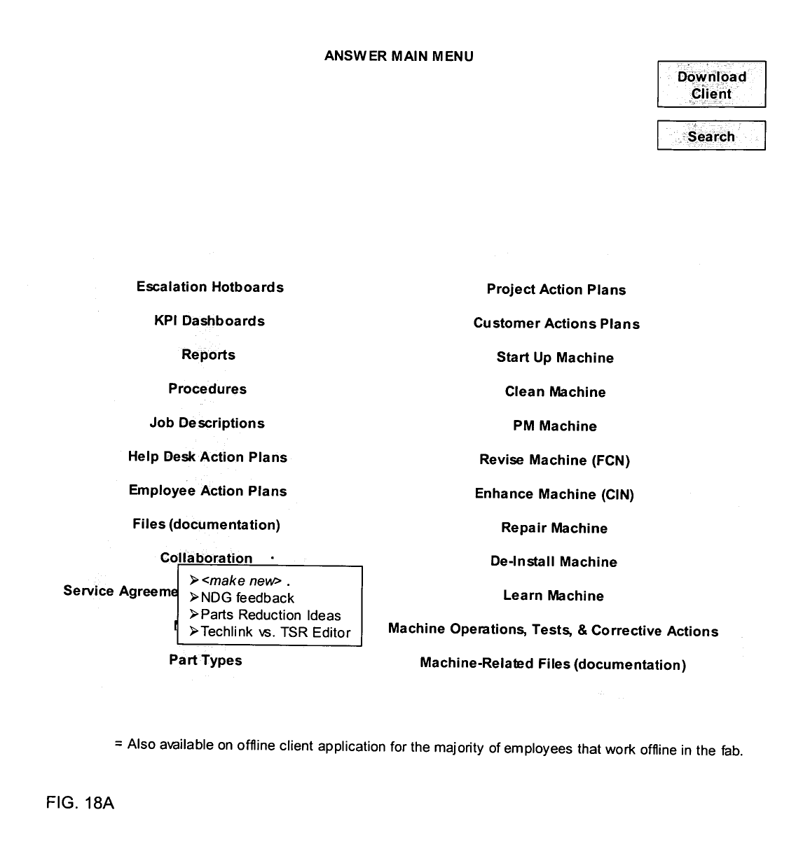

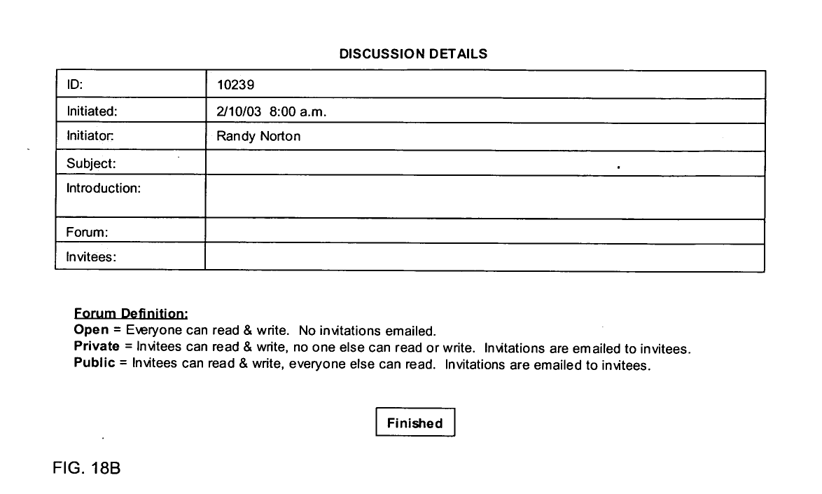

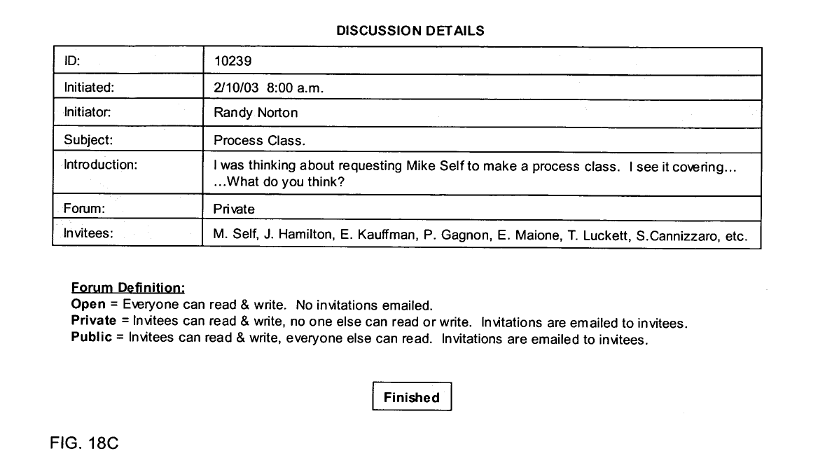

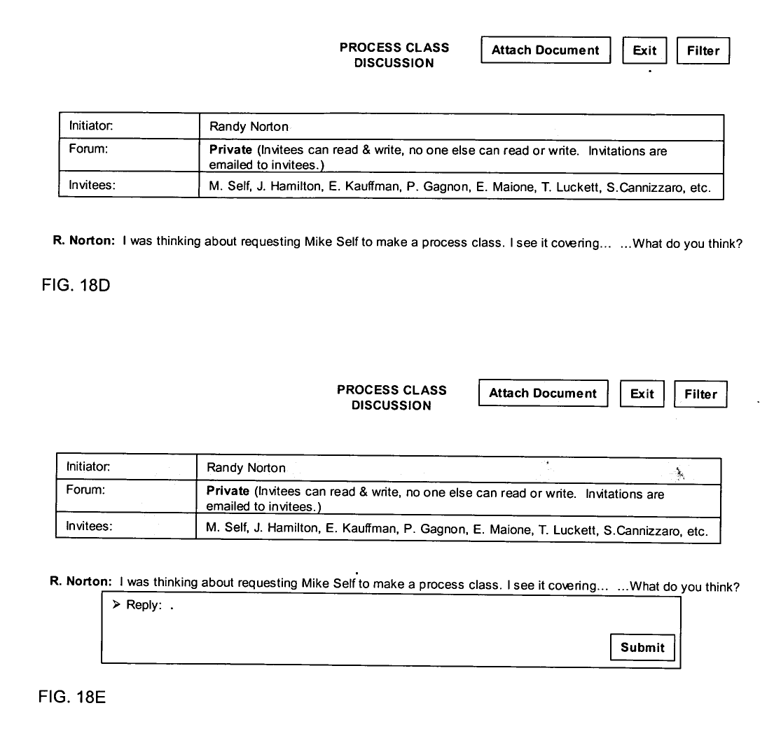

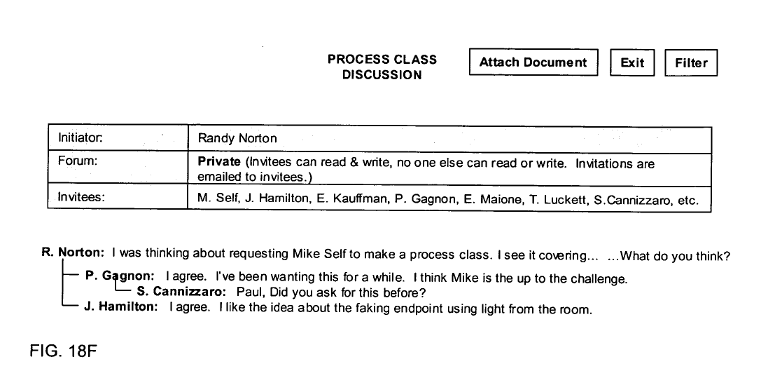

In yet another example, a service operator can create a new collaboration amongst service operators, or join an existing collaboration amongst service operators. As shown in FIG. 18A, the service operator can access new and existing collaborations through the GUI using the “Collaboration” key. For example, as shown in FIG. 18B, a service operator can open a new collaboration, wherein an identification (ID) number, a date and time for initiating the collaboration, and an identification of the initiator is provided. The service operator can further enter a subject for the collaboration, an introduction to the collaboration, a definition of the forum for collaboration, and a definition of invitees to the collaboration; see FIG. 18C. The forum can, for instance, include: an “Open” forum, wherein everyone can have read and write access, and no invitations are provided; a “Private” forum, wherein only invitees have read and write access, and the invitees are provided invitations; and a “Public” forum, wherein invitees have read and write access, everyone else has read access, and invitations are provided to the invitees.

Once the collaboration is initiated, the collaboration can be accessed via the GUIusing the “Collaboration” key; see FIG. 18A. FIG. 18D presents an existing collaboration, wherein a first service operator initiates the discussion. FIGS. 18E and 18F illustrate the reply of several other service operators to the first service operator. Thereafter, if the invitees to the collaboration agree to a new service action, then one of the service operators can enter the new service action to any one of employee action plans, help desk action plans, project action plans, or customer action plans.

As described in the examples above, the activity management system 1 interfaces with a system user, such as a service operator, to perform various service functions data that are useful for service operators to perform service actions. The following methods describe service operators' interaction with the activity management system 1 to perform specific service actions.

Service Component Repair

According to one embodiment, a method for performing service component repair can include the following steps. (1) An identification of a service component repair requirement; (2) Assignment of a repair service process to a service operator, such as a service repair engineer, using the activity management system; and (3) The activity management system lists a repair history summary for this service component. Each repair uploaded by all service operators before the last time the service operator synchronized with the activity management system 1 is shown. The activity management system 1 shows initial failure, corrective action, and whether the corrective action appears ineffective. The history goes back to the start of final test performed during installation of the equipment.

(4) The service operator enters a machine test noun/s (e.g., “Etch Rate, 51A5”, etc.) that failed in the activity management system. (5) If the activity management system has seen this failure before, it provides an interactive case study. (The activity management system pulls all cases that match the current test results recorded on the current case. It then lists additional test verb/nouns (e.g., “Test RF Forward Power Level”) done on matching cases, and additional change verb/nouns (e.g., “Clean ESC”) done on matching cases. The tests are prioritized by isolating the probability and time required. The changes are prioritized by number of times the change repaired matching cases. The service engineer can filter by service component model, process type, or customer.

(6) The service operator then diagnoses (troubleshoots) the problem. (7) The service operator can select tests done on matching cases (ideal), select a test not done on matching cases, make new tests, or just describe a test with free text. The activity management system marks new tests for review. The tests can be recorded upon completion (with results) or planned for the future. The activity management system extracts the service component-specific test from the selected verb/noun group (allows user to make a verb/noun group if none exists). The activity management system knows the service component by looking at the s/n-specific indented key parts bill of materials (BOM). The tests are shown in actual action plans (assigned service operators, service components, etc.) as sub-tasks under the repair parent task.

(8) The service operator can read key performance indicators (KPIs) (specifications) or instructions in the activity management system by clicking associated buttons next to the test in the action plan. (9) The service operator can search for and read the clear service component description and theory of operation diagrams in the activity management system. (10) The service operator can enter closed tasks in the activity management system. The service operator can transfer open tasks to another service operator. (11) The service operator logs service component repair test results in the activity management system. The service operator can log test results in the activity management system (e.g., “Test RF Forward Power Level”). The activity management system displays results log for that task. A Results Log Example may include Specification Name: “Power Meter Before Matcher to Power Setting,” Target Level: “X,” Actual Level: “Y,” and any Comments.

(12) The service operator then corrects the problem. (13) The service operator can select change/s done on matching cases, select change/s not done on matching cases, make new change/s, or just describe change/s with free text. The activity management system marks new changes for review. Change/s can be recorded upon completion or planned for the future (particularly when replacing MS parts since the MS part needs to be ordered). The activity management system extracts the service component-specific change from the selected verb/noun group. The activity management system knows the service component by looking at the serial number (s/n)-specific indented key parts BOM (bill of materials). The change/s is shown in actual action plans (assigned service operators, service components, etc.) as sub-task/s under the repair parent task. (14) The service operator can also read instruction/s in the activity management system by clicking associated button/s next to the change in the action plan. (15) If change verb is “replace” and the change noun is a “part type”, the activity management system makes a MS part order system task.

(16) The activity management system notifies the service operator when the case is solved (all tests that failed are currently passing), highlights MS parts that were not part of the solution so they can be removed, and highlights MS parts that were replaced together (shot-gunned) so they can be further isolated. The service operator can continue working or close the case. (17) The activity management system adds this case to its interactive case study (unless service operator declines due to problems with documenting the case). (18) Another service operator, such as technical support, reviews new tests and changes, and deletes or changes to an existing test or change if required.

Service Component Cleaning

According to another embodiment, a method for performing service component cleaning can include the following steps (1) A service operator generates a cleaning procedure for this service component in the activity management system based on the service component design, process experience, and maintenance experience. A series of steps are generated that specify the start criteria for each clean step based on calendar, wafer (substrate) counter, or RF timer (typically one (1) year long).

(2) The service operator generates cleaning instruction/s for this service component in the activity management system based on service component design, process experience, and maintenance experience. An important set of MS parts required is the service component-specific clean kit. (3) The service operator can link the service component test, change, and operation instructions to the steps in the cleaning instruction/s in the activity management system. (4) The service operator, such as a service supervisor/manager, assigns a cleaning procedure to a customer service component in the activity management system. (5) The service operator, such as service supervisor/manager, assigns assignees to cleaning procedure steps in the activity management system that he or she wants tracked.

(6) An identification is made that the service component requires cleaning. If the start criterion is based on calendar, the activity management system initiates when it is time. If the start criterion is based on wafer counter or RF timer, the activity management system initiates, if applicable, when the service component counters are updated. The service operators are requested to update service component counters whenever they work on the service component, and once a day. Service component counters can be updated real-time if e-monitoring is established. (7) The service operator selects a MS part order system task for the clean kit part type. The activity management system generates a MS part request system task associated with the cleaning parent task and assigned to the service operator and the service component.

(8) The service operator logs service component cleaning test results in the activity management system. The service operator can access the results log (e.g., “Test P/C Leak Rate”). The activity management system displays the results log for that task. Results Log Example: Product Part Type: PC, Product S/N: SCCM55-PC1, Specification Name: Self Check P/C Leak Rate Result, Target: 3, Final Test Actual: 2, Actual: Comments: (9) The service operator enters closed tasks to the activity management system. The service operator can transfer open tasks to another service operator. (10) The service operator can read KPI's (specifications) or instructions in the activity management system as well by clicking associated buttons next to the task in the action plan. (11) If test result fails, the activity management system makes a repair system task associated to the test sub-task and assigned to the service operator and the customer service component. The activity management system also enters the machine test noun (e.g., “P/C Leak Rate”) that failed.

Service Component Replacement

According to another embodiment, a method for performing a service component replacement, such as the replacement of a MS part, can include the following steps. (1) Notification that the service component requires replacement; (2) The service operator assigns the replacement task to himself or herself, and a service component replacement, such as a clean kit, in the activity management system; and (3) The service operator can forward the task to another service operator.

(4) The service operator enters how often the clean kit is replaced on the MS Platform or MS tool (e.g., 300 wafers, 14 days, or 300 RF hours) in the activity management system. (5) If the MS part/s actual lifetime (tracked in the activity management system) exceeds the typical lifetime (specified in the activity management system) before use through another process cycle in the MS platform or MS tool, the activity management system generates a MS part order system task for that MS part/s associated with the service operator and the service component replacement, or clean kit. (6) If the MS part/s is damaged, the service operator selects a MS part order system task. (7) The service operator cleans other MS parts, or returns them to a cleaning center for cleaning.

(8) The activity management system tracks MS part locations (e.g., warehouse, trash, kit BOM, or floating), and the MS part characteristics by part serial number (s/n). The service operator enters when the replacement MS part is lost, received (including s/n), opened, added to the clean kit, removed from the clean kit, etc. The service operator enters why replacement MS part is not added to the clean kit (e.g., wrong MS part, MS part not required, duplicate MS part, MS part damaged, MS part not ordered, MS part mis-labeled, etc.). The activity management system determines whether the replacement MS part has an approved purchasing account. Another service operator can investigate the MS part s/n discrepancies.

Performing Preventive Maintenance

According to another embodiment, a method for performing preventative maintenance (PM) on a service component, such as a MS platform, a MS tool, or a MS part, can include the following steps. (1) A service operator, such as a service designer, generates a PM procedure for this product in the activity management system based on service component design, engineering experience, and maintenance experience. A series of steps are provided that each specify the start criteria for each PM step based on calendar, wafer counter, or RF timer (typically 1 year long). (2) A service operator, such as a technical writer, generates PM instruction/s for this service component in the activity management system. For example, the service component PM can include a service component-specific PM kit. (3) The service operator can link the service component test, change, and operation instructions to the steps in the PM instruction/s in the activity management system.

(4) A service operator, such as a service manager, assigns a PM procedure to a customer service component in the activity management system. (5) The service manager assigns service operators (assignees) to PM procedure steps in the activity management system that he or she wants tracked. (6) Identification is made that a service component requires PM. If the start criterion is based on calendar, the activity management system initiates when it is time for PM. If the start criterion is based on wafer counter, or RF timer, the activity management system initiates, if applicable, when the service component counters are updated. The service operators are requested to update service component counters whenever they work on the service component, and once a day. The service component counters can be updated real-time if e-monitoring is established.

(7) A service operator, such as PM technician, reviews PM tasks on the activity management system. (8) The PM technician selects a MS part order system task for the PM kit MS part type. The activity management system generates a MS part request system task associated with the PM parent task, and assigned to the service operator and customer service component. (9) The PM technician enters the service component PM test results in the activity management system. A service operator can then access a results log for that task. A Results Log Example includes Product Part Type: “PC,” Product S/N: “SCCM55-PC1,” Specification Name: “Self Check P/C Leak Rate Result,” Target: “3,” Final Test Actual: “2,” and any Comments. (10) The PM technician enters closed tasks to the activity management system. The service operator can forward open tasks to another service operator. (11) The PM technician can review KPI's (specifications) or instructions in the activity management system. (12) If the test result fails, the activity management system can generate a repair system task associated with the test sub-task, and assigned to the service operator and customer service component. The activity management system also enters the service component test noun (e.g., “P/C Leak Rate”, etc.) that failed.

Service Component Installation

According to another embodiment, a method for performing a service component installation, such as the installation of a MS platform, a MS tool, or a MS part, can include the following steps (1) A service operator, such as service manager, generates an installation procedure in the activity management system. The final test step and start up step are linked to the respective instructions. (2) A service operator, such as service designer, enters new steps originated with the specific service component to the final test instruction and start up instruction in the activity management system. (3) A service operator, such as technical writer, links service component test, change, and operation instructions using their verb/noun group to the new steps in the final test instruction and the start up instruction in the activity management system. (4) The service operator generates s/n-specific service component BOM of the plurality of MS parts to “track from start” (e.g., MS platform, MS tool, clean kit, PM kit, etc.) in the activity management system. The activity management system can add a temporary s/n where the s/n is unknown. If the MS part does not exist in the activity management system, then it is entered. An example of this entry includes: P/N: “ES1 D80-1231 -01,” Part Common Name: “12 inch Ceramic ESC,” Part Official Name: “X” Part Type: “ESC,” Lifetime: “3000,” Special Disposition: “SD23.” (5) The service operator enters customer identification, purchasing account, etc. For example: P/N: “ES1D80-1231-01,” Part S/N: “ANS-343,” Part Nickname: “X”, Parent Part S/N: “PC1-SCCM68.”

(6) A service operator, such as service manager, assigns the installation procedure to a customer service component in the activity management system. (7) The service manager assigns other service operators (assignees) to installation procedure steps in the activity management system that he or she wants tracked. (8) The activity management system generates s/n-specific final test instruction and s/n-specific start up instruction in the activity management system by extracting the service component-specific instructions from the verb/noun group listed in the final test instruction and the start up instruction. The activity management system can recognize the service component from the s/n-specific indented key parts BOM. The steps are shown in actual action plans (e.g., assigned service operators, service components, etc) as sub-tasks under the final test or start up parent task.

Modification of Service Component

According to another embodiment, a method for performing a modification to a service component, such as a modification to a MS platform, MS tool, or MS part, can include the following steps. (1) Identification that special modification to an existing service component is required. (2) A service operator, such as a service manager, determines whether to pursue (e.g., considers estimated cost, priorities of resources, and customer's willingness to purchase), whether to request that the customer does not perform the modification (e.g., modification can lead to problems), or whether to request (or allow) the customer to pursue the modification on their own. (3) If the service operator, such as service manager, determines that a new MS part design is required, then a solution can be designed, a prototype constructed, and the solution tested.

(4) The service operator generates specification documents for purchased MS parts (e.g., off-the-shelf MS parts), designed MS parts, and MS part assemblies. Documents can include supplier/s and supplier/s part number. Documents can also include text, physical drawings, and schematic drawings, or any combination thereof. Documents can further include revision (e.g., no effect on form, fit, or function). (5) The service operator assigns engineering numbers to MS parts, MS part assemblies, and MS part specification documents. Engineering numbers can include version (e.g., customer, country, etc.) and suffix (e.g., indicates backward compatibility). (6) The service operator generates indented BOM's for MS part assemblies. (7) The service operator generates release notes for software. (8) The service operator generates modification installation instructions in the activity management system. (9) The service operator can link the service component test, change, and operation instructions to the steps in the modification installation instruction/s in the activity management system. (10) The service operator, such as a service manager, assigns modification installation instructions to affected service components in the activity management system. (11) The service manager assigns service operators (assignees) to the modification installation task in the activity management system.

(12) An identification is made that a service component requires modification installation. If the start criterion is based on calendar, the activity management system initiates when it is time. If the start criterion is based on wafer counter or RF timer, the activity management system initiates, if applicable, when the service component counters are updated. The service operators are requested to update service component counters whenever they work on the service component and once a day. The service component counters can be updated real-time if e-monitoring is established. (13) The service operator, such as one assigned to performing the modification, logs modification test results in the activity management system. The service operator can access test results through the activity management system (e.g., results of “Test P/C Leak Rate”). A Results Log Example includes Product Part Type: “PC,” Product S/N: “SCCM55-PC1,” Specification Name: “Self Check P/C Leak Rate Result,” Target: “3,” Final Test Actual: “2,” Actual: “X” and any Comments. (14) The service operator can enter closed tasks into the activity management system, transfer open task to another service operator through the activity management system. (15) If the test result fails, the activity management system can generate a repair system task associated with the test sub-task and assigned to the service operator and customer service component. The activity management system also enters the machine test noun (e.g., “P/C Leak Rate”) that failed.

Service Component De-installation

According to another embodiment, a method for performing a service component de-installation, such as the de-installation of a MS platform, a MS tool, or a MS part, can include the following steps (1) Identification that a service component de-installation is required; and (2) A service operator assigns the de-Installation system task to himself, or herself, and the customer service component in the activity management system. (3) The service operator de-installs the service component. (4) The service operator enters closed tasks into the activity management system. The service operator can transfer open tasks to another service operator. (5) If the MS part is missing, or an additional MS part is required, the service operator can select a part order system task. (6) If the service component requires repair, the activity management system generates a repair system task associated with the test sub-task and assigned to the service operator and the customer service component. The activity management system also enters the service component test noun (e.g., “RF Forward Power Level”) that failed.

Part Ordering

According to another embodiment, a method for performing a MS part order using the activity management system can include the following steps. (1) Identification that a MS part order is required. (2) A service operator generates a MS part order system task in the activity management system. If needed for an individual service task (as is the typical case), the activity management system correlates the MS part order with the parent task number. (3) If the service operator provides the MS part type, the activity management system lists MS part/s (and the MS part/s hierarchy) in the service component BOM that matches that MS part type. (4) The service operator selects from the list or adds an MS part to the service component BOM based FRU number ID document. If the MS part does not already exist in the activity management system, the service operator generates a new MS part. For example: P/N: “ES1D80-1231-01,” Part Common Name: “12 inch Ceramic ESC,” Part Official Name: “X”, Part Type: “ESC.”

(5) The activity management system recommends the quantity, purchasing account based on service component's service agreement/s and whether part is consumable (i.e., warranty, contract, paid service purchase order, etc), the shipping priority (e.g., “need part shipped”, “overnight”, etc.), the shipping address used last time for this service component, any shipping comments (e.g., “don't email estimated time of arrival (ETA) unless the MS part can not be shipped ‘overnight’”), and a temporary s/n where the s/n is unknown. (6) The service operator confirms the MS part order information and edits this information in the activity management system if necessary. The activity management system prompts the service operator to consider active purchasing accounts. The service operator can add more than one MS part to order if necessary. (7) The activity management system acquires the MS part price. If the customer is purchasing, or the MS part is relatively inexpensive, not recently replaced, and best-known-methods have been followed, the activity management system can auto-approve the MS part order.

(8) The activity management system notifies the service operator when payment and shipment is approved or denied. (9) If associated with a service task (e.g., Repair, Start Up, etc.), the MS part remains with that task even if the task transfers to different service operators (assignees). (10) The activity management system notifies the service operator of the ETA and tracking number if required. (11) The MS part is shipped if required.

(12) The activity management system tracks the MS part locations (e.g., warehouse, trash, service component BOM, or floating), and the MS part characteristics by part s/n. The service operator enters information pertaining to when the replacement MS part is lost, received (e.g., s/n entered), opened, installed, and removed into the activity management system. The service operator enters why the replacement MS part is removed (e.g., MS part not solution, or MS part damaged). The service operator enters why the replacement MS part is never installed (e.g., wrong MS part, MS part not required, MS part duplicate, MS part damaged, MS part not ordered, or MS part mis-labeled). The activity management system determines whether the original MS part is good, bad, or unknown when removed (e.g., s/n confirmed/entered). The activity management system enters whether the replacement MS part has an approved purchasing account. A service operator can investigate the MS part s/n discrepancies.

Generate MS Part Failure Key Point Indicator (KPI)

According to another embodiment, the activity management system generates a MS part failure key point indicator (KPI) analysis using the following method (1) The activity management system generates a MS part failure KPI dashboard, and includes non-consumable MS part replacements and consumable parts that failed before their lifetime target. (2) A service operator, such as service analyst, analyzes performance on MS part failure KPI dashboard in the activity management system. The service operator selects the type of MS part failure KPI dashboard (e.g., All, Service component-Specific, Customer-Specific, etc.). The activity management system lists each MS part with these KPI's in the columns: e.g., quantity, cost, repair time, average lifetime in days, wafers and RF hours, and lifetime target (if specified for consumable). Any column can be sorted up or down. The list can be filtered (including date range). (3) The service operator can periodically identify the top five MS parts overall, and the top 0-3 for each service component (0 if low usage or low priority market) using the MS part failure KPI dashboard in the activity management system.

(4) If not done in the previous period, the service operator reviews the repair history in the activity management system, and initiates corrective action to change the maintenance if that's where the problem lies (e.g., revise training, revise documentation, send a bulletin, etc.). (5) If the service operator determines that a new maintenance design (e.g., clean per new instruction) needs to be announced, then a service operator generates a description of the problem and a solution, and lists the customers that have the old maintenance design. and (6) If the problem doesn't appear to be maintenance-related and not done in the previous period, the service operator generates a return for analysis special disposition.

Generate MS Part Consumption Key Point Indicator (KPI)

According to another embodiment, the activity management system generates a MS part consumption key point indicator (KPI) analysis using the following method. (1) The activity management system generates a MS part consumption KPI dashboard that includes consumable parts. (2) A service operator, such as service analyst, analyzes the performance of MS part consumption KPI dashboard in the activity management system. The service operator selects the type of MS part consumption KPI dashboard (e.g., “All”, “Service component-Specific”, “Customer-Specific”, etc.). The activity management system lists each MS part with these KPI's in the columns: e.g., quantity, cost, repair time, average lifetime in days, wafers and RF hours, and lifetime target (if specified for consumable). Any column can be sorted up or down. (3) The service operator can periodically identify the top five MS parts overall, and the top 0-3 for each service component (0 if low usage or low priority market) using the MS part consumption KPI dashboard in the activity management system.

(4) If not done in the previous period, the service operator reviews the repair history in the activity management system, and initiates corrective action to change the maintenance if that's where the problem lies (e.g., revise training, revise documentation, send a bulletin, etc.). (5) If the service operator determines that a new maintenance design (e.g., clean per new instruction) needs to be announced, then a service operator generates a description of the problem and a solution, and lists the customers that have the old maintenance design. (6) If the problem doesn't appear to be maintenance-related and not done in the previous period, the service operator generates a return for analysis special disposition.

Generate a MS Part Disposition Recommendation

According to another embodiment, the activity management system can be utilized to generate a MS part disposition recommendation. Therein, a service operator, such as a service designer, generates, for example, a standard disposition (e.g., scrap, return to stock, etc.) for standard MS parts, and a special disposition (e.g., return for repair, return for analysis, return due to exchange, etc.) for special parts in the activity management system that provides a disposition recommendation for various MS part state changes. If a special disposition is repair, another service operator, such as technical support, can provide input for the disposition recommendation. If a special disposition is for exchange or analysis, another service operator, such as technical support, can enter the quantity (e.g., how many bad matchers to buy, or a desired size of sample analysis batch, etc.). If the MS part does not exist in the activity management system, then it can be entered as a new part; for example: P/N: “ES1 D80-1231-01,” Part Common Name: “12 inch Ceramic ESC,” Part Official Name: “X”, Part Type: “ESC,” Lifetime: “3000,” Special Disposition: “SD23.”

Returning MS Parts

According to another embodiment, a method for returning MS parts using the activity management system can include the following steps (1) An identification that a MS part return is required. (2) A service operator, such as a part return specialist, generates a MS part return system task in the activity management system. If the MS part return system task is related to an individual service task (as is the typical case), the activity management system associates the task with the parent task. (3) If the service operator provides the MS part s/n (even the temporary s/n assigned by the activity management system), the activity management system displays the MS part characteristics/location, and recommends disposition (e.g., ask a specific service operator, give to owner, scrap, send to MS part analysis center, send to MS part repair/cleaning center, return to stock, keep for troubleshooting, etc.). Additionally, the activity management system determines whether to decontaminate the MS part based on standard, or special disposition configuration.

(4) If the MS part is being returned for analysis or repair/cleaning, the activity management system recommends a purchasing account (e.g., warranty, contract, paid service purchase order (PO), department, etc). (5) The service operator confirms the MS part return information and edits any information in the activity management system if necessary. The activity management system prompts the service operator to consider active purchasing accounts (for analysis and repair/cleaning). Another service operator, such as a part order specialist, can add more than one MS part to return if necessary. The service operator may need to get a quote from the analysis/repair/cleaning center before getting PO from customer. (6) If returning to stock, the activity management system notifies the customer service center to approve and enter a return materials authorization (RMA) number in the activity management system. The activity management system sends the RMA number to the service operator. If returning for analysis or repair/cleaning that wasn't recommended by the activity management system, the activity management system notifies another service operator, such as technical support, to approve and enter the RMA number If returning for analysis or repair/cleaning that was recommended by the activity management system, the activity management system approves and enters the RMA number.

(7) If shipping outside the country, the activity management system generates a non-inventory shipping authorization (NISA). (8) Import-Export provides a commercial invoice to the service operator. (9) The service operator decontaminates/seals the MS part. The activity management system generates a MS part return form to place upon the MS part. The service operator prints forms and ships them with the MS part and the commercial invoice. (10) The service operator enters the tracking number in the activity management system. (11) The customer service center enters the tracking number in the activity management system. If the MS part simply requires placement back into stock, or placement back into stock with a new label, the activity management system marks the disposition as closed. If the MS part is being repaired/cleaned and placed into a warehouse, the activity management system obtains the core value based on the special disposition in the activity management system, credits the purchasing account (e.g., warranty, paid service PO (on an exchange program), etc), and notifies the customer service center.

Performing MS Part Analysis

According to another embodiment, a method for performing MS part analysis using the activity management system can include: (1) An identification that MS part analysis is required; (2) A part analysis center analyzes a MS part/batch, makes a MS part analysis report and MS part analysis invoice, notifies one or more service operators, such as technical support, a part return specialist and a part analysis requester, and ships the MS part to the MS part owner. If the MS part is owned by the service provider, they may, for example, elect to repair or scrap the MS part; (3) A service operator, such as technical support, attaches the MS part analysis report to the MS part (by s/n) or the MS part number (if batch was analyzed) in the activity management system, marks the disposition as closed for each MS part, and marks the MS part as not part of a solution if analysis shows that the MS part was good after all; and (4) A service operator, such as the part analysis requestor, generates a MS part analysis payment.

Perform MS Part Repair or Cleaning

According to another embodiment, a method for performing MS part repair or cleaning using the activity management system can include: (1) An identification that MS part repair or cleaning is required; (2) A MS part repair/cleaning center repairs/cleans the MS part, makes the MS part repair/cleaning report and part repair/cleaning invoice, notifies one or more service operators, such as technical support and a part owner (e.g., customer or service provider warehouse, customer, etc.), and ships the MS part to the part owner; (3) A service operator, such as technical support, attaches the MS part repair/cleaning report to the MS part (by s/n) in the activity management system, and marks the disposition as closed; and (4) The MS part owner generates a MS part repair/cleaning payment.

Performing MS Part Revision

According to another embodiment, a method for performing MS part revision using the activity management system can include the following steps. (1) A service operator, such as a service manager, defines a MS part problem/opportunity, and identifies that a new MS part design is required. (2) Another service operator, such as a sustaining engineer, designs a solution, constructs a prototype, and tests the solution. (3) The other service operator, i.e., sustaining engineer, generates specification documents for purchased MS parts (e.g., off-the-shelf), designed MS parts, and MS part assemblies. The documents can include the supplier/s and the supplier/s part number. The documents can also include text, physical drawings, or schematic drawings, or any combination thereof. The documents can further include revision (e.g., no effect on form, fit, or function). (4) The sustaining engineer assigns engineering numbers to the MS parts, MS part assemblies, and specification documents, wherein the engineering numbers can include version (customer, country, etc), and a suffix (indicates backward compatibility). (5) The sustaining engineer generates indented BOM's for MS part assemblies. (6) The sustaining engineer generates release notes for the software.

(7) If the service operator, i.e., service manager, determines that a new MS part design needs to be installed in existing service components, e.g., MS platform or MS tool, to make them meet purchasing or safety requirements, the sustaining engineer generates a field change notice (FCN) (e.g., customer acceptance form that describes problem and solution), and a list of service components that have the old MS part design (the data can be stored in the activity management system). If the service manager determines that a new MS part design requires installation in only new service components, or in existing service components when the old MS part fails or wears out, or when the customer wants to purchase, the sustaining engineer generates a continuous improvement notice (CIN) (report that describes opportunity) and list of service components that have the old MS part design (the data can be stored in the activity management system).

Perform Field Chance Notice (FCN)

According to another embodiment, a method for performing a field change notice (FCN) using the activity management system can include the following steps. (1) A service operator, such as a sustaining engineer, generates FCN installation instruction/s for each affected service component in the activity management system. The new MS part/s are listed in the MS parts required. (2) The sustaining engineer can link the service component test, change, and operation instructions to the steps in the FCN installation instruction/s in the activity management system. (3) Another service operator, such as technical support, generates a FCN procedure for this FCN in the activity management system. Thereafter, the FCN can, for example, be presented to the customer for review and approval. The start criterion for the install FCN step can be based on calendar, wafer counter, or RF timer. (4) Another service operator, such as a FCN planner, assigns the FCN procedure to affected service components in the activity management system. (5) The FCN planner assigns service operators (assignees) to the FCN procedure steps in the activity management system that he or she wants tracked.

(6) If the FCN is rejected by the customer, a service operator, such as a service manager, can determine how to proceed (e.g., “Will the customer use the new design when old MS part fails/wears out or will the service provider need to continue to supply old MS part?”). (7) If the FCN is approved by the customer, a service operator, such as a FCN installer, selects a MS part order system task for the FCN MS parts. The activity management system generates a MS part order system task associated with the FCN parent task and assigned to the FCN installer and customer service component.

(8) An identification is made that a service component requires FCN installation. If the start criterion is based on calendar, the activity management system initiates the FCN when it is time. If the start criterion is based on wafer counter or RF timer, the activity management system initiates the FCN, if applicable, when machine counters are updated. Service operators are requested to update service component counters whenever they work on the service component, and once a day. Service component counters can be updated real-time if e-monitoring is established. (9) The FCN installer logs FCN test results in the activity management system. The FCN installer can access FCN test results (e.g., “Test P/C Leak Rate”), and display those results. A Results Log Example includes Product Part Type: “PC,” Product S/N: “SCCM55-PC1,” Specification Name: “Self Check P/C Leak Rate Result,” Target: “3,” Final Test Actual: “2,” Actual: “X” and any Comments. (10) The FCN installer enters closed tasks to the activity management system. The FCN installer can transfer open tasks to another FCN installer. (11) The FCN installer can read KPI's (specifications) or instructions in the activity management system. (12) If test result fails, the activity management system generates a repair system task associated with the test sub-task and assigned to the FCN Installer and customer service component. The activity management system also enters the service component test noun (e.g., “P/C Leak Rate”) that failed.

Perform Continuous Improvement Notice (CIN)

According to another embodiment, a method for performing a continuous improvement notice (CIN) using the activity management system can include the following steps. (1) A service operator, such as a sustaining engineer, generates CIN installation instruction/s for each affected service component in the activity management system. The new MS part/s are listed in the MS parts required. (2) The sustaining engineer can link the service component test, change, and operation instructions to the steps in the CIN installation instruction/s in the activity management system. (3) Another service operator, such as technical support, generates a CIN procedure for this CIN in the activity management system. Thereafter, the CIN can, for example, be presented to the customer for review and approval. The start criteria for the install CIN step can be based on calendar, wafer counter, or RF timer. (4) Another service operator, such as a CIN planner, assigns the CIN procedure to affected service components in the activity management system. (5) The CIN planner assigns service operators (assignees) to the CIN procedure steps in the activity management system that he or she wants tracked.

(6) If the CIN is rejected by the customer, a service operator, such as a service manager, can determine how to proceed (e.g., “Will the customer use the new design when old MS part fails/wears out or will the service provider need to continue to supply old MS part?”). (7) If the CIN is approved by the customer, a service operator, such as a CIN installer, selects a MS part order system task for the CIN MS parts. The activity management system generates a MS part order system task associated with the CIN parent task and assigned to the CIN installer and customer machine.

(8) An identification is made that a service component requires CIN installation. If the start criterion is based on calendar, the activity management system initiates the CIN when it is time. If the start criterion is based on wafer counter or RF timer, the activity management system initiates the CIN, if applicable, when machine counters are updated. Service operators are requested to update service component counters whenever they work on the service component, and once a day. Service component counters can be updated real-time if e-monitoring is established. (9) The CIN installer logs CIN test results in the activity management system. The CIN installer can access CIN test results (e.g., “Test P/C Leak Rate”), and display those results. A Results Log Example includes: Product Part Type: “PC,” Product S/N: “SCCM55-PC1,” Specification Name: “Self Check P/C Leak Rate Result,” Target: “3,” Final Test Actual: “2,” Actual: “X” and any Comments. (10) The CIN installer enters closed tasks to the activity management system. The CIN installer can transfer open tasks to another CIN installer. (11) The CIN installer can read KPI's (specifications) or instructions in the activity management system. (12) If test result fails, the activity management system generates a repair system task associated with the test sub-task and assigned to the CIN Installer and customer service component. The activity management system also enters the service component test noun (e.g., “P/C Leak Rate”) that failed.

Service Management KPI Analysis

According to another embodiment, a method for performing service management KPI analysis using the activity management system can include the following steps: (1) The activity management system generates a service manager/supervisor KPI dashboard. (2) A service operator, such as a service analyst, analyzes performance on the service manager/supervisor KPI dashboard in the activity management system. The service analyst selects the type of service manager/supervisor KPI dashboard (e.g., “All”, “Me”, “My Direct Reports”, “My Department”, “Other Person's Direct Reports”, “Other Person's Department”, etc.). The activity management system lists each service manager/supervisor with these KPI's in the columns: e.g., position, contract sales revenue, contract profit, contract profit margin, warranty sales revenue, warranty profit, warranty profit margin, paid service sales revenue, paid service profit, paid service profit margin, overtime (OT) cost, late FCNs, late system acceptances, escalated calls, etc. Any column can be sorted up or down. The list can be filtered (including date range). (3) The service analyst initiates corrective action for poor performance and affirming action for exceptional performance. The activity management system may provide a suggestion. (4) If the service manager determines that affirming action needs to be announced, then the service manager generates a bulletin in the activity management system.

Service Agreement KPI Analysis

According to another embodiment, a method for performing service agreement KPI analysis using the activity management system can include the following steps: (1) The activity management system generates a service agreement KPI dashboard. (2) A service operator, such as a service analyst, analyzes performance on the service agreement KPI dashboard in the activity management system. The service analyst selects the type of service agreement KPI dashboard (e.g., “All”, “Product-Specific”, “Company-Specific”, etc.). The activity management system lists each service component with these KPI's in the columns: e.g., sales revenue, profit, profit margin, parts cost, man-hours cost, calls, escalated calls, repair time, downtime, etc. Any column can be sorted up or down. The list can be filtered (including date range). (3) The service analyst initiates corrective action for poor performance and affirming action for exceptional performance. The activity management system may provide a suggestion. (4) If a service operator, such as a service manager, determines that corrective action or affirming action (e.g., service agreement was cancelled.) needs to be announced, then the service manager generates a bulletin in the activity management system.

Service Worker KPI Analysis

According to another embodiment, a method for performing service worker KPI analysis using the activity management system can include the following steps. (1) The activity management system generates a service worker KPI dashboard. (2) A service operator, such as a service analyst, analyzes the performance on service worker KPI dashboard in the activity management system. The service analyst selects the type of service worker KPI dashboard (e.g., “All”, “Me”, “My Direct Reports”, “My Department”, “Other Person's Direct Reports”, “Other Person's Department”, etc.). The activity management system lists each service worker with these KPI's in the columns: e.g., position, shotguns, ineffective corrective actions, department charges, late parts dispositions, machine labor man-hours, OT hours, billable hours, IOE, calls, final tests, start ups, cleans, PMs, repairs, escalated calls, etc. Any column can be sorted up or down. The list can be filtered (including date range). (3) The service analyst initiates corrective action for poor performance and affirming action for exceptional performance. The activity management system may provide a suggestion. (4) If a service operator, such as a service manager, determines that affirming action needs to be announced, then the service manager generates a bulletin in the service activity management system.

Service Component KPI Analysis

According to another embodiment, a method for performing service component (e.g., MS platform, MS tool, etc.) KPI analysis using the activity management system can include the following steps. (1) The activity management system generates a service component KPI dashboard. (2) A service operator, such as a service analyst, analyzes performance on the service component KPI dashboard in the activity management system. The service analyst selects the type of service component KPI dashboard (e.g., “All”, “Product-Specific”, “Company-Specific”, etc.). The activity management system lists each service component with these KPI's in the columns: e.g., contract sales revenue, contract profit, contract profit margin, contract parts cost, contract man-hours cost, warranty sales revenue, warranty profit, warranty profit margin, warranty parts cost, warranty man-hours cost, paid service sales revenue, paid service profit, paid service profit margin, late FCNs, system acceptance delay, calls, escalated calls, repair time, downtime, etc. Any column can be sorted up or down. The list can be filtered (including date range). (3) The service analyst initiates corrective action for poor performance and affirming action for exceptional performance. The activity management system may provide a suggestion. (4) If a service operator, such as a service manager, determines that corrective action or affirming action (e.g., machine was returned to factory.) needs to be announced, then the service manager generates a bulletin in the activity management system.

Customer KPI Analysis

According to another embodiment, a method for performing customer KPI analysis using the activity management system can include the following steps. (1) The activity management system generates a customer KPI dashboard. (2) A service operator, such as a service analyst, analyzes the performance on the customer KPI dashboard in the activity management system. The activity management system lists each customer with these KPI's in the columns: e.g., contract sales revenue, contract profit, contract profit margin, warranty sales revenue, warranty profit, warranty profit margin, paid service sales revenue, paid service profit, paid service profit margin, OT cost, late FCNs, late system acceptances, escalated calls, etc. Any column can be sorted up or down. The list can be filtered (including date range). (3) The service analyst initiates corrective action for poor performance and affirming action for exceptional performance. The activity management system may provide a suggestion. (4) If a service operator, such as a service manager, determines that corrective action or affirming action (e.g., customer must give PO's in advance.) needs to be announced, then the service manager generates a bulletin in the activity management system.

Safety Incident Report

According to another embodiment, a method for performing a safety incident report using the activity management system can include the following steps: (1) Identification that a safety incident occurred. (2) A service operator, such as a safety incident reporter, generates a safety incident system task in the activity management system. If related to an individual service task (as is the typical case), the activity management system associates the safety incident with the parent task. (3) The service operator enters safety incident information into the activity management system. (4) The activity management system transfers (via, for example, electronic mail) the safety incident report to the safety officer (or environmental, health, and safety group) for the service provider.

Service Component Operations. Tests, and Changes

According to another embodiment, a method for preparing service component operations, tests, and changes can include the following steps (1) A service operator, such as a service designer, generates a service component BOM of MS parts to document. The MS parts must be marked products in their MS part type. For example: Product #: “B,” Part Common Name: “Telius Platform,” Parent Product #: “A2.” The service designer generates new service component test nouns (e.g., “RF Forward Power Level”) originated with this service component in the activity management system. (2) The service designer generates new change verbs (e.g., “clean”, “lube”, “replace”, etc.), and change nouns (e.g., MS part types such as “ESC”, or functions such as “Matcher Mode”, “RF Forward Power Level”) originated with this service component in the activity management system. (3) The service designer generates new operation verbs (e.g., “edit”, “start”, “view”, “cycle”, “close”), and operation nouns (e.g., “machine”, “parameters”) originated with this service component in the activity management system. (4) The service designer generates service component tests (e.g., “Test Telius DRM RF Forward Power Level”) for this service component in the aqctivity management system. The test can include KPI/s (specification/s). KPI Example: Power Meter Before Matcher to Power Setting: Target: —, Units: watts, Lo Fail: −3%, Lo Warn: —, Hi Warn: —, Hi Fail: +3%, Opinion: No., Application: UM. Sub-KPI (variation for special application such as final test, start up, clean, PM): Target: 1000, Units: watts, Lo Fail: −3%, Lo Warn: —, Hi Warn: —, Hi Fail: +3%, Opinion: No., Application: Start Up x, PM y. (5) The service designer generates changes (e.g., “Clean Telius DRM ESC”) for this service component in the activity management system. Changes can include setup, corrective action, and preventative action. (6) The service designer generates operations (e.g., “Create a New Process Recipe”) for this product in the activity management system.

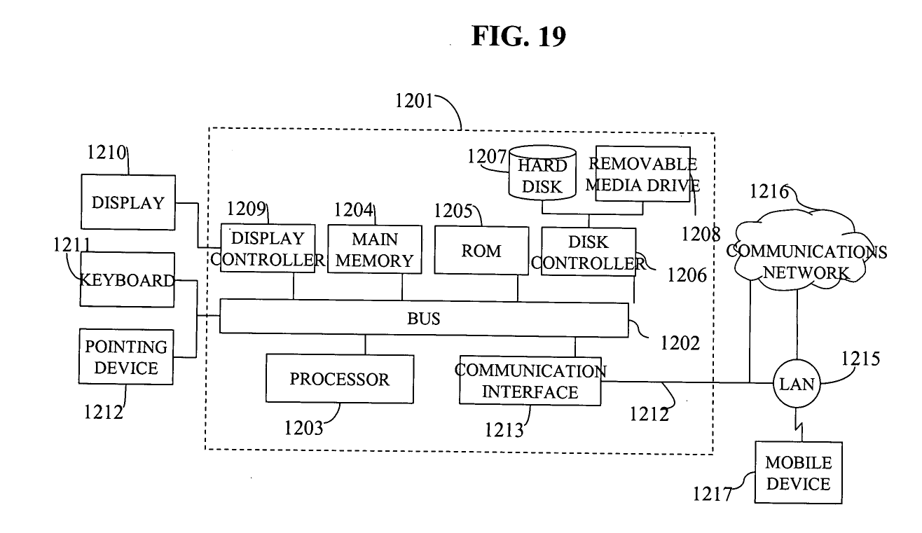

FIG. 19 illustrates a computer system 1201 upon which an embodiment of the present invention may be implemented. The computer system 1201 may be used as any one or all of the data collection system 10, the data storage system 20, the service action system 30 or the interface of FIG. 1 to perform any or all of the functions described above. The computer system 1201 includes a bus 1202 or other communication mechanism for communicating information, and a processor 1203 coupled with the bus 1202 for processing the information. The computer system 1201 also includes a main memory 1204, such as a random access memory (RAM) or other dynamic storage device (e.g., dynamic RAM (DRAM), static RAM (SRAM), and synchronous DRAM (SDRAM)), coupled to the bus 1202 for storing information and instructions to be executed by processor 1203. In addition, the main memory 1204 may be used for storing temporary variables or other intermediate information during the execution of instructions by the processor 1203. The computer system 1201 further includes a read only memory (ROM) 1205 or other static storage device (e.g., programmable ROM (PROM), erasable PROM (EPROM), and electrically erasable PROM (EEPROM)) coupled to the bus 1202 for storing static information and instructions for the processor 1203.

The computer system 1201 also includes a disk controller 1206 coupled to the bus 1202 to control one or more storage devices for storing information and instructions, such as a magnetic hard disk 1207, and a removable media drive 1208 (e.g., floppy disk drive, read-only compact disc drive, read/write compact disc drive, compact disc jukebox, tape drive, and removable magneto-optical drive). The storage devices may be added to the computer system 1201 using an appropriate device interface (e.g., small computer system interface (SCSI), integrated device electronics (IDE), enhanced-IDE (E-IDE), direct memory access (DMA), or ultra-DMA).

The computer system 1201 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)). The computer system may also include one or more digital signal processors (DSPs) such as the TMS320 series of chips from Texas Instruments, the DSP56000, DSP56100, DSP56300, DSP56600, and DSP96000 series of chips from Motorola, the DSP1600 and DSP3200 series from Lucent Technologies or the ADSP2100 and ADSP21000 series from Analog Devices. Other processors especially designed to process analog signals that have been converted to the digital domain may also be used.

The computer system 1201 may also include a display controller 1209 coupled to the bus 1202 to control a display 1210, such as a cathode ray tube (CRT), for displaying information to a computer user. The computer system includes input devices, such as a keyboard 1211 and a pointing device 1212, for interacting with a computer user and providing information to the processor 1203. The pointing device 1212, for example, may be a mouse, a trackball, or a pointing stick for communicating direction information and command selections to the processor 1203 and for controlling cursor movement on the display 1210. In addition, a printer may provide printed listings of data stored and/or generated by the computer system 1201.

The computer system 1201 performs a portion or all of the processing steps of the invention in response to the processor 1203 executing one or more sequences of one or more instructions contained in a memory, such as the main memory 1204. Such instructions may be read into the main memory 1204 from another computer readable medium, such as a hard disk 1207 or a removable media drive 1208. One or more processors in a multi-processing arrangement may also be employed to execute the sequences of instructions contained in main memory 1204. In alternative embodiments, hard-wired circuitry may be used in place of or in combination with software instructions. Thus, embodiments are not limited to any specific combination of hardware circuitry and software.

As stated above, the computer system 1201 includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer readable media, the present invention includes software for controlling the computer system 1201, for driving a device or devices for implementing the invention, and for enabling the computer system 1201 to interact with a human user (e.g., print production personnel). Such software may include, but is not limited to, device drivers, operating systems, development tools, and applications software. Such computer readable media further includes the computer program product of the present invention for performing all or a portion (if processing is distributed) of the processing performed in implementing the invention.

The computer code devices of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

The term “computer readable medium” as used herein refers to any medium that participates in providing instructions to the processor 1203 for execution. A computer readable medium may take many forms, including but not limited to, non-volatile media, volatile media, and transmission media. Non-volatile media includes, for example, optical, magnetic disks, and magneto-optical disks, such as the hard disk 1207 or the removable media drive 1208. Volatile media includes dynamic memory, such as the main memory 1204. Transmission media includes coaxial cables, copper wire and fiber optics, including the wires that make up the bus 1202. Transmission media also may also take the form of acoustic or light waves, such as those generated during radio wave and infrared data communications.

Various forms of computer readable media may be involved in carrying out one or more sequences of one or more instructions to processor 1203 for execution. For example, the instructions may initially be carried on a magnetic disk of a remote computer. The remote computer can load the instructions for implementing all or a portion of the present invention remotely into a dynamic memory and send the instructions over a telephone line using a modem. A modem local to the computer system 1201 may receive the data on the telephone line and use an infrared transmitter to convert the data to an infrared signal. An infrared detector coupled to the bus 1202 can receive the data carried in the infrared signal and place the data on the bus 1202. The bus 1202 carries the data to the main memory 1204, from which the processor 1203 retrieves and executes the instructions. The instructions received by the main memory 1204 may optionally be stored on storage device 1207 or 1208 either before or after execution by processor 1203.

The computer system 1201 also includes a communication interface 1213 coupled to the bus 1202. The communication interface 1213 provides a two-way data communication coupling to a network link 1214 that is connected to, for example, a local area network (LAN) 1215, or to another communications network 1216 such as the Internet. For example, the communication interface 1213 may be a network interface card to attach to any packet switched LAN. As another example, the communication interface 1213 may be an asymmetrical digital subscriber line (ADSL) card, an integrated services digital network (ISDN) card or a modem to provide a data communication connection to a corresponding type of communications line. Wireless links may also be implemented. In any such implementation, the communication interface 1213 sends and receives electrical, electromagnetic or optical signals that carry digital data streams representing various types of information.

The network link 1214 typically provides data communication through one or more networks to other data devices. For example, the network link 1214 may provide a connection to another computer through a local network 1215 (e.g., a LAN) or through equipment operated by a service provider, which provides communication services through a communications network 1216. The local network 1214 and the communications network 1216 use, for example, electrical, electromagnetic, or optical signals that carry digital data streams, and the associated physical layer (e.g., CAT 5 cable, coaxial cable, optical fiber, etc). The signals through the various networks and the signals on the network link 1214 and through the communication interface 1213, which carry the digital data to and from the computer system 1201 maybe implemented in baseband signals, or carrier wave based signals. The baseband signals convey the digital data as unmodulated electrical pulses that are descriptive of a stream of digital data bits, where the term “bits” is to be construed broadly to mean symbol, where each symbol conveys at least one or more information bits. The digital data may also be used to modulate a carrier wave, such as with amplitude, phase and/or frequency shift keyed signals that are propagated over a conductive media, or transmitted as electromagnetic waves through a propagation medium. Thus, the digital data may be sent as unmodulated baseband data through a “wired” communication channel and/or sent within a predetermined frequency band, different than baseband, by modulating a carrier wave. The computer system 1201 can transmit and receive data, including program code, through the network(s) 1215 and 1216, the network link 1214, and the communication interface 1213. Moreover, the network link 1214 may provide a connection through a LAN 1215 to a mobile device 1217 such as a personal digital assistant (PDA) laptop computer, or cellular telephone.

Although only certain exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

1. An activity management system for managing service activities relating to semiconductor manufacturing comprising:
a data collection system configured to receive service activity data relating to at least one of a service component, a service operator, and a service account;
a data storage system coupled to said data collection system and configured to store said service activity data; and
a service action system coupled to said data collection system and said data storage system, and configured to provide service action data using said service activity data by performing at least two of a plurality of service functions comprising providing service component repair, providing service component start-up, providing service component preventative maintenance, providing service component cleaning, providing service component revisions, providing service component enhancements, providing service component de-installation, providing service education, and providing service collaboration.

2. The activity management system of claim 1, wherein said plurality of service functions further comprises setting project action plans, setting customer action plans, setting service component operations, tests and corrective actions, setting service component documentation, setting escalation hot-boards, setting key point indicator dashboards, preparing reports, setting procedures, setting job descriptions, setting help desk action plans, setting employee action plans, defining service agreements, and defining service components.

3. The activity management system of claim 1, wherein said service component includes at least one of a manufacturing system (MS) platform, a manufacturing system (MS) tool, and a manufacturing system (MS) part.

4. The activity management system of claim 3, wherein said MS platform includes at least one of a cluster tool arrangement, and a serial tool arrangement.

5. The activity management system of claim 4, wherein said MS tool comprises at least one of an etch system, a deposition system, a track system, a thermal system, an ion implant system, a lithography system, a planarization system, a metrology system, and a test system.

6. The activity management system of claim 4, wherein said MS part comprises at least one of a consumable part, and a non-consumable part.

7. The activity management system of claim 1, wherein said service account includes at least one of a service contract, a service warranty, and a manufacturing system department.

8. The activity management system of claim 1, wherein said data collection system, said data storage system, and said data action system are configured as at least one of a web-based software application, and a downloadable client software application.

9. The activity management system of claim 1, further comprising:
an operator interface coupled to said data collection system and configured to provide an interface for said service operator to enter said service activity data to said data storage system, and coupled to said service action system and configured to provide an interface for said service operator to extract said service action data from said data action system.

10. The activity management system of claim 9, wherein said operator interface includes a graphical user interface (GUI).

11. The activity management system of claim 1, wherein said data action system is configured to perform said service component repair by performing an interactive case study.

12. The activity management system of claim 11, wherein said service action system provides at least one of a test for said service component and a corrective action for said service component by matching current service activity data for said service component with said service activity data stored in said data storage system.

13. The activity management system of claim 12, wherein said service action system is configured to provide a procedure for said test.

14. The activity management system of claim 12, wherein said service action system is configured to provide a procedure for said corrective action.

15. The activity management system of claim 12, wherein said service component includes a MS tool, and said corrective action includes a replacement of a MS part in said MS tool.

16. The activity management system of claim 15, wherein said activity management system is configured to track a first MS part and a second MS part, said first MS part replaces said second MS part in said MS tool.

17. The activity management system of claim 12, wherein said service action system utilizes a result from said test to provide at least one of another test for said service component and another corrective action for said service component by matching said result with said service activity data stored in said data storage program.

18. The activity management system of claim 3, wherein said service component comprises a MS tool with one or more MS parts, and said service action system is configured to associate said one or more MS parts with said MS tool.

19. The activity management system of claim 2, wherein said data collection system is configured to permit a first service operator to assign a task to a second service operator for at least one of an employee action plan, a customer action plan, and a project action plan.

20. The activity management system of claim 2, wherein said service action system is configured to provide service action data to a first operator in order to assess the performance of a second service operator.

21. A method of using an activity management system to assist in performing a service action relating to semiconductor manufacturing comprising:
providing a data collection system configured to interact with a service operator and collect service activity data from said service operator, wherein said service activity data is associated with at least one of a service operator, a service component, and a service account;
providing a data storage system coupled to said data collection system, and configured to store said service activity data;
providing a service action system coupled to said data collection system and said data storage system, and configured to interact with said service operator to provide service action data to said service operator using said service activity data stored in said data storage system in order to perform at least two of a plurality of service functions comprising service component repair, providing service component start-up, providing service component preventative maintenance, providing service component cleaning, providing service component revisions, providing service component enhancements, providing service component de-installation, providing service education, and providing service collaboration; and
utilizing said service action data to perform a service action.

22. An activity management system for managing service activities relating to semiconductor manufacturing comprising:
a data collection system configured to collect service activity data relating to semiconductor manufacturing services;
a data storage system coupled to said data collection system and configured to store said service activity data; and
a service action system coupled to said data collection system and data storage system and configured to perform a service component service function and a non-service component service function in order to assist a service operator in performing a service action.

23. The activity management system of claim 22, wherein said data collection system is configured to collect said service activity data by manual input.

24. The activity management system of claim 22, wherein said data collection system is configured to collect said service activity data by automatic input.

25. The activity management system of claim 22, wherein said data collection system collects service activity data related to at least one of a service component, a service operator, and a service account.

26. The activity management system of claim 22, wherein said data storage system stores said service activity data in association with at least one of a service component, a service operator, and a service account.

27. The activity management system of claim 22, wherein said service action system is configured to perform said service component service function by performing at least one of service component repair, providing service component start-up, providing service component preventative maintenance, providing service component cleaning, providing service component revisions, providing service component enhancements, providing service component de-installation, and providing service education

28. The activity management system of claim 22, wherein said service action system is configured to perform said non-service component service function by allowing a service operator to:
interface with project action plans or customer action plans;
integrate a new test or corrective action or amend a current test or corrective action;
enter a new documentation pertaining to a MS platform, a MS tool, a MS part, or a MS service agreement;
review, enter, or amending escalation hot-boards;
access key performance indicator (KPI) dashboards, reports, procedures, job descriptions, help desk action plans, employee action plans, or files;
collaborate with other service operators; or
access information relating to MS service agreements, MS platforms and MS tools, and MS parts.

29. The activity management system of claim 22, wherein said service action system is further configured to provide service action data used by the service operator to perform service actions.

30. A method of using a computer system to manage service activities relating to semiconductor manufacturing comprising:
using said computer system to collect service activity data relating to semiconductor manufacturing services;
using said computer system to store said service activity data; and
using said computer system to perform a service component service function and a non-service component service function; and
performing a service action based on results of said service component or non-service component service function.

31. The method of claim 30, wherein said collecting said service activity data comprises manual input.

32. The method of claim 30, wherein said collecting said service activity data comprises automatic input.

33. The method of claim 30, wherein said collecting comprises collecting service activity data related to at least one of a service component, a service operator, and a service account.

34. The method of claim 30, wherein said storing comprises storing said service activity data in association with at least one of a service component, a service operator, and a service account.

35. The method of claim 30, wherein said performing a service component service function comprises providing service action data to facilitate at least one of service component repair, providing service component start-up, providing service component preventative maintenance, providing service component cleaning, providing service component revisions, providing service component enhancements, providing service component de-installation, and providing service education.

36. The method of claim 30, wherein performing said non-service component service function comprises providing service action data allowing a service operator to:
interface with project action plans or customer action plans;
integrate a new test or corrective action or amend a current test or corrective action;
enter a new documentation pertaining to a MS platform, a MS tool, a MS part, or a MS service agreement;
review, enter, or amending escalation hot-boards;
access key performance indicator (KPI) dashboards, reports, procedures, job descriptions, help desk action plans, employee action plans, or files;
collaborate with other service operators; or
access information relating to MS service agreements, MS platforms and MS tools, and MS parts.

37. A computer readable medium containing program instructions for execution on a processor, which when executed by the processor, cause a computer system to perform the steps in the method recited in claim 30.

38. An activity management system for managing service activities relating to semiconductor manufacturing comprising:
means for collecting service activity data relating to semiconductor manufacturing services;
means for storing said service activity data coupled to said means for collecting; and
means, coupled to said means for collecting and said means for storing, for performing a service component service function and a non-service component service function in order to assist a service operator in performing a service action.
